(19) United States
(12) Patent Application Publication
(10) Pub. No.: US 2015/0249272 A1
(43) Pub. Date: Sep. 3, 2015

(54) SODIUM SECONDARY BATTERY

(71) Applicant: SUMITOMO ELECTRIC INDUSTRIES, LTD., Osaka-shi (JP)

(72) Inventors: Shoichiro Sakai, Osaka-shi (JP); Koma Numata, Osaka-shi (JP); Eiko Itani, Osaka-shi (JP); Atsushi Fukunaga, Osaka-shi (JP); Koji Nitta, Osaka-shi (JP); Shinji Inazawa, Osaka-shi (JP)

(73) Assignee: SUMITOMO ELECTRIC INDUSTRIES, LTD., Osaka-shi (JP)

(21) Appl. No.: 14/427,224

(22) PCT Filed: Sep. 10, 2013
(86) PCT No.: PCT/JP2013/074401

§ 371 Date: Mar. 10, 2015

(30) Foreign Application Priority Data
Sep. 10, 2012 (JP) 2012-198715

(51) Int. Cl. H01M 10/39; H01M 4/587

(52) U.S. Cl. CPC H01M 10/399; H01M 4/587; H01M 2004/027

(57) ABSTRACT

The present invention relates to a sodium secondary battery comprising a positive electrode which includes a positive electrode current collector and a positive electrode material, the positive electrode material being carried on the positive electrode current collector, wherein the positive electrode material comprises a positive electrode active material reversibly containing sodium cation; a negative electrode which includes a negative electrode current collector and a negative electrode material, the negative electrode material being carried on the negative electrode current collector, wherein the negative electrode material comprises a negative electrode active material reversibly containing sodium cation; an electrolyte interposed at least between the positive electrode and the negative electrode; and a separator for retaining the electrolyte and separating the positive electrode and the negative electrode from each other; wherein the negative electrode active material is amorphous carbon, and the electrolyte is a molten salt electrolyte which is a mixture of a salt composed of sodium cation and an anion and a salt composed of an organic cation and an anion.

### TECHNICAL FIELD

The present invention relates to a sodium secondary battery. Particularly, the present invention relates to a sodium secondary battery useful as, for example, a power source for a vehicle, an electricity storage device for electric power storage in power networks, and the like.

### BACKGROUND ART

A sodium secondary battery is expected to be used for power sources of electric vehicles, leveling of electric power demand, output stabilization in power generation using natural energy including solar energy and wind power energy, and the like. As the sodium secondary battery, for example, a sodium secondary battery including a negative electrode including metallic sodium or a sodium alloy, and a nonaqueous electrolytic solution in an organic solvent has been proposed (see, for example, Patent Literature 1).

### CITATION LIST

### Patent Literature

Patent Literature 1: Japanese Unexamined Patent Publication No. 2010-102917

### SUMMARY OF INVENTION

### Technical Problem

However, since a sodium secondary battery including a nonaqueous electrolytic solution includes an organic solvent in the nonaqueous electrolytic solution, depending upon the operating temperatures of the sodium secondary battery, the charged capacity and the discharged capacity may be reduced due to, for example, volatilization of the organic solvent. Furthermore, in the sodium secondary battery, since the negative electrode includes metallic sodium or a sodium alloy, metallic sodium is precipitated with the repeated charge and discharge and dendrites of the metallic sodium grow, so that sufficient charge and discharge cycle characteristics may not be obtained.

On the other hand, as a negative electrode active material, it is possible to consider the use of an insertion material such as graphite which seems to have excellent charge and discharge performance, for example, a material accompanied with an intercalation phenomenon, namely, insertion of ions into the atomic arrangement structure or desorption thereof from the structure at the time of charge and discharge. However, even when the insertion material which seems to have excellent charge and discharge performance is used as the negative electrode active material in the sodium secondary battery, excellent cycle life characteristics may not be obtained.

Therefore, development of sodium secondary batteries having a high charged capacity and a high discharged capacity and excellent charge and discharge cycle characteristics has been demanded.

The present invention has been made in view of the above-mentioned conventional technique, and aims to provide a sodium secondary battery having a high charged capacity and a high discharged capacity and having excellent charge and discharge cycle characteristics.

### Solution to Problem

A sodium battery of the present invention is

(1) a sodium secondary battery including a positive electrode which includes a positive electrode current collector and a positive electrode material, the positive electrode material being carried on the positive electrode current collector, wherein the positive electrode material includes a positive electrode active material reversibly containing sodium cation; a negative electrode which includes a negative electrode current collector and a negative electrode material, the negative electrode material being carried on the negative electrode current collector, wherein the negative electrode material includes a negative electrode active material reversibly containing sodium cation; an electrolyte interposed at least between the positive electrode and the negative electrode; and a separator for retaining the electrolyte and separating the positive electrode and the negative electrode from each other; wherein the negative electrode active material is amorphous carbon particles, and the electrolyte is a molten salt electrolyte which is a mixture of a salt composed of sodium cation and an anion and a salt composed of an organic cation and an anion.

### Advantageous Effects of Invention

The present invention can provide a sodium secondary battery having a high charged capacity and a high discharged capacity and excellent charge and discharge cycle characteristics.

### BRIEF DESCRIPTION OF DRAWINGS

FIG. 1 is a graph showing charge/discharge curves of half cells obtained in Experimental Examples 1 to 3, respectively, in Test Example 1.

FIG. 2 is a graph showing examination results of the relation between the number of cycles and the charged capacity of half cells obtained in Experimental Examples 1 to 3, respectively, in Test Example 1.

FIG. 3 is a graph showing examination results of the relation between the number of cycles and the capacity retention rate of half cells obtained in Experimental Examples 1 and 4, respectively, in Test Example 2.

FIG. 4 is a graph showing charge/discharge curves of half cells obtained in Experimental Example 1, in Test Example 2.

FIG. 5 is a graph showing charge/discharge curves of half cells obtained in Experimental Examples 5 and 6, respectively, in Test Example 3.

FIG. 6 is a graph showing charge/discharge curves of half cells obtained in Experimental Example 7, in Test Example 4.

FIG. 7 is a graph showing charge/discharge curves of half cells obtained in Experimental Example 7 in Test Example 4.

FIG. 8 is a graph showing examination results of the relation between the number of cycles and each of the charged capacity, the discharged capacity and the Coulomb efficiency, in Test Example 4.

FIG. 9 is a graph showing charge/discharge curves of a sodium secondary battery obtained in Example 1, in Test Example 5.

FIG. 10 is a graph showing examination results of the relation between the number of cycles and each of the charged capacity and the discharged capacity, in Test Example 5.

### MODES FOR CARRYING OUT THE INVENTION

### Description of Embodiments of the Invention

First, embodiments of the present invention are listed and the descriptions thereof are given.

The embodiments of the present invention include a sodium secondary battery including a positive electrode which includes a positive electrode current collector and a positive electrode material, the positive electrode material being carried on the positive electrode current collector, wherein the positive electrode material includes a positive electrode active material reversibly containing sodium cation; a negative electrode which includes a negative electrode current collector and a negative electrode material, the negative electrode material being carried on the negative electrode current collector, wherein the negative electrode material includes a negative electrode active material reversibly containing sodium cation; an electrolyte interposed at least between the positive electrode and the negative electrode; and a separator for retaining the electrolyte and separating the positive electrode and the negative electrode from each other; wherein the negative electrode active material is amorphous carbon, and the electrolyte is a molten salt electrolyte which is a mixture of a salt composed of sodium cation and an anion and a salt composed of an organic cation and an anion.

Since the sodium secondary battery of the present invention which employs the above-mentioned configuration includes amorphous carbon as the negative electrode active material, sodium cation is reversibly contained in the amorphous carbon without precipitation of metallic sodium and growth of dendrites during charge and discharge. Namely, the sodium cation is inserted into an atomic arrangement structure of the amorphous carbon in the negative electrode or is desorbed from the inside of the atomic arrangement structure of the amorphous carbon. Furthermore, in the sodium secondary battery of the present invention which employs the above-mentioned configuration, since the molten salt electrolyte includes an organic cation as a cation, resistance at the time when the sodium cation is inserted into the amorphous carbon or the sodium cation is desorbed from the atomic arrangement structure of the amorphous carbon can be reduced, thus enabling the insertion of the sodium cation into the atomic arrangement structure of the amorphous carbon or desorption of the sodium cation from the atomic arrangement structure of the amorphous carbon to be carried out smoothly. Therefore, the sodium secondary battery of the present invention which employs the above-mentioned configuration exhibits a high charged capacity and a high discharged capacity, and can exhibit excellent charge and discharge cycle characteristics.

It is preferable that the amorphous carbon is non-graphitizable carbon. The negative electrode including the non-graphitizable carbon enables more sodium cations to be inserted into the negative electrode active material, and also reduces the volume change due to the insertion or desorption of the sodium cation. Therefore, the sodium secondary battery of the present invention which employs the above-mentioned configuration shows a higher charged capacity and a higher discharged capacity and has a longer lifetime.

The shape of the non-graphitizable carbon is a particle shape, and the average particle diameter (d₅₀) of each particle is preferably 5 to 15 μm, more preferably 7 to 12 μm.

When the average particle diameter (d₅₀) of each particle is not less than 5 μm, the increase in the irreversible capacity of the non-graphitizable carbon negative electrode can be suppressed. When the average particle diameter (d₅₀) of the particles is not more than 15 μm, the decrease in the utilization ratio and rate property of the non-graphitizable carbon negative electrode can be suppressed.

The content of water in the molten salt electrolyte is preferably not more than 0.01% by mass, more preferably not more than 0.005% by mass. From the viewpoint of suppressing the increase in the irreversible capacity of the non-graphitizable carbon negative electrode and maintaining excellent performance of the sodium secondary battery, it is desirable to set the content of water in the molten salt electrolyte preferably at not more than 0.01% by mass, more preferably at not more than 0.005% by mass by controlling materials constituting a battery and controlling the manufacturing process.

The content percentage of the metal cation other than the sodium cation in all the cations in the molten salt electrolyte is preferably not more than 5% by mol. In the sodium secondary battery of the present invention which employs the above-mentioned configuration, sodium cations can be inserted into the negative electrode active material and desorbed from the negative electrode active material more efficiently. Therefore, the sodium secondary battery of the present invention which employs the above-mentioned configuration exhibits a higher charged capacity and a higher discharged capacity as well as higher charge and discharge cycle characteristics.

The anion is preferably a sulfonyl amide anion represented by the below-mentioned formula (I), more preferably at least one selected from the group consisting of a bis(trifluoromethyl sulfonyl)amide anion, a fluorosulfonyl(trifluoromethyl sulfonyl)amide anion, and a bis(fluorosulfonyl)amide anion. The sodium secondary battery of the present invention which employs the above-mentioned configuration exhibits excellent charge and discharge cycle characteristics.

The organic cation is preferably at least one selected from the group consisting of a cation represented by the below-mentioned formula (IV), an imidazolium cation represented by the below-mentioned formula (V), a pyridinium cation represented by the below-mentioned formula (VII), a pyrrolidinium cation represented by the below-mentioned formula (X), and a piperidinium cation represented by the below-mentioned formula (XII). The sodium secondary battery of the present invention which employs the above-mentioned configuration can perform a charge and discharge reaction under low-temperature conditions.

The organic cation is preferably at least one selected from the group consisting of N-methyl-N-propylpyrrolidinium cation and 1-ethyl-3-methylimidazolium cation. The sodium secondary battery of the present invention which employs the above-mentioned configuration can perform a more stable charge and discharge reaction under low-temperature conditions.

The molten salt electrolyte is preferably at least one selected from the group consisting of a mixture of sodium bis(fluorosulfonyl)amide and N-methyl-N-propylpyrrolidinium bis(fluorosulfonyl)amide and a mixture of sodium bis(fluorosulfonyl)amide and 1-ethyl-3-methylimidazolium, and the amount of sodium bis(fluorosulfonyl)amide per 1 mol of the mixture is preferably 0.1 to 0.55 mol, more preferably 0.2 to 0.5 mol.

When the amount of sodium bis(fluorosulfonyl)amide per 1 mol of the mixture is not less than 0.1 mol, the rate property when the charge and discharge reaction of the sodium secondary battery is carried out can be improved. Furthermore, when the amount of sodium bis(fluorosulfonyl)amide per 1 mol of the mixture is not more than 0.55 mol, the increase in the viscosity of the molten salt electrolyte can be suppressed, the decrease in the permeability of the molten salt electrolyte in the sodium secondary battery can be suppressed, and working efficiency of an operation of filling an electrolytic solution into the sodium secondary battery at the time of manufacturing the sodium secondary battery can be improved.

### DETAILED DESCRIPTION OF EMBODIMENTS OF THE INVENTION

Next, specific examples of a secondary battery as one embodiment of the present invention are described. It is construed that the present invention is not limited to such examples but shown by the claims, and all the modifications made within the scope that is equivalent to the claims and having the same meaning as the claims are intended to be encompassed by the present invention.

One of major features of the sodium secondary battery as one embodiment of the present invention resides in that the sodium secondary battery is a sodium secondary battery including a positive electrode which includes a positive electrode current collector and a positive electrode material, the positive electrode material being carried on the positive electrode current collector, wherein the positive electrode material includes a positive electrode active material reversibly containing sodium cation; a negative electrode which includes a negative electrode current collector and a negative electrode material, the negative electrode material being carried on the negative electrode current collector, wherein the negative electrode material includes a negative electrode active material reversibly containing sodium cation; an electrolyte interposed at least between the positive electrode and the negative electrode; and a separator for retaining the electrolyte and separating the positive electrode and the negative electrode from each other; wherein the negative electrode active material is amorphous carbon, and the electrolyte is a molten salt electrolyte which includes sodium cation and an organic cation. Since the sodium secondary battery as one embodiment of the present invention has the above-mentioned configuration, sodium cation is inserted into an atomic arrangement structure of the amorphous carbon in the negative electrode or is desorbed from the inside of the atomic arrangement structure of the amorphous carbon without precipitation of metallic sodium and growth of dendrites during charge and discharge. Furthermore, since the electrolyte includes an organic cation, even if the surface of the amorphous carbon is not subjected to hydrophilization treatment, wettability of the negative electrode active material with respect to the electrolyte can be secured. Thus, it seems that resistance at the time when the sodium cation is inserted into an atomic arrangement structure of the amorphous carbon or the sodium cation is desorbed from the atomic arrangement structure of the amorphous carbon can be reduced, thus enabling the insertion of the sodium cation into the atomic arrangement structure of the amorphous carbon or desorption of the sodium cation from the atomic arrangement structure of the amorphous carbon to be carried out smoothly. Therefore, the sodium secondary battery which is one embodiment of the present invention exhibits a high charged capacity and a high discharged capacity, and can exhibit excellent charge and discharge cycle characteristics.

The expression “reversibly containing sodium cation” in the present specification means that the positive electrode active material and the negative electrode active material have a function of inserting the sodium cation into the active material and desorbing it to the outside of the active material at the time of charge and discharge.

The sodium secondary battery as one embodiment of the present invention can be manufactured by, for example, putting an electrode unit including a positive electrode, a negative electrode, and a separator which separates the positive electrode and the negative electrode from each other into a battery case main body having an opening part, then filling a molten salt electrolyte containing sodium cation into the battery case main body containing the electrode unit, and then sealing the battery case main body. The molten salt electrolyte has only to be interposed at least between the positive electrode and the negative electrode.

The electrode unit is configured, for example, by disposing the positive electrode, the negative electrode and the separator in such a manner that a carrying surface of a positive electrode active material in the positive electrode and a carrying surface of a negative electrode active material in the negative electrode face each other with the separator interposed therebetween. Both the positive and negative electrodes and the separator are brought into contact with each other in such a manner that they are pressed to each other.

The positive electrode is an electrode which includes a positive electrode current collector and a positive electrode material, the positive electrode material being carried on the positive electrode current collector, wherein the positive electrode material includes a positive electrode active material reversibly containing sodium cation. The positive electrode material includes the positive electrode active material, and, if necessary, a conductive auxiliary agent and a binder.

Examples of the material constituting the positive electrode current collector include aluminum and the like, but the present invention is not limited to such examples. Among them, aluminum is preferable because aluminum has high current collecting property and is capable of improving the charged capacity and the discharged capacity of the sodium secondary battery.

Furthermore, examples of shapes of the positive electrode current collector include a foil, a porous body, and the like, but the present invention is not limited to such examples. When the shape of the positive electrode current collector is a porous body, the porosity of the porous body is preferably not less than 90%, more preferably not less than 97% from the viewpoint of sufficiently securing the charged capacity and the discharged capacity of the sodium secondary battery. Furthermore, the upper limit value of the porosity can be appropriately set as long as the mechanical strength of the current collector can be sufficiently secured. The porosity of the current collector in this specification is a value obtained according to the following calculation formula (1).

[Porosity of porous body]=(1−true volume of porous body/apparent volume of porous body)×100 (1)

The thickness of the positive electrode current collector cannot be determined uniformly because it is different depending upon the shape of the positive electrode current collector, the application of the sodium secondary battery, or the like. Therefore, it is preferable that the thickness be appropriately determined according to the shape of the positive electrode current collector, the application of the sodium secondary battery, or the like.

Examples of the positive electrode active material include a sulfide, an oxide, a halide, and the like, which are capable of reversibly containing sodium cation, but the present invention is not limited to such examples. Examples of the sulfide, the oxide, and the halide capable of reversibly containing sodium cation include a sulfide such as TiS₂; a sodium transition metal oxide such as NaMn_{1.5}Ni_{0.5}O₄, NaFeO₂, NaMnO₂, NaNiO₂, NaCrO₂, NaCoO₂, and Na_{0.44}MnO₂; a sodium transition metal silicate such as Na₆Fe₂Si₁₂O₃₀, Na₂Fe₅Si₁₂O₃₀, Na₂Fe₂Si₆O₁₈, Na₂MnFeSi₆O₁₈, and Na₂FeSiO₆; a sodium transition metal phosphate such as NaCoPO₄, NaNiPO₄, NaMnPO₄, NaFePO₄, and Na₃Fe₂(PO₄)₃; a sodium transition metal fluorophosphate such as Na₂FePO₄F and NaVPO₄F; a sodium transition metal fluoride such as Na₃FeF₆, NaMnF₃, and Na₂MnF₆; a sodium transition metal borate such as NaFeBO₄ and Na₃Fe₂(BO₄)₃; and the like, but the present invention is not limited to such examples. Among these sulfides, oxides, and halides capable of reversibly containing sodium cation, NaCrO₂ (sodium chromite) is preferable from the viewpoint of improving the charge and discharge cycle characteristics and the energy density.

Examples of the conductive auxiliary agent include carbon blacks such as acetylene black and Ketjen black, but the present invention is not limited to such examples. Usually, the content percentage of the conductive auxiliary agent in the positive electrode material is preferably not more than 15% by mass.

Examples of the binder include glass, liquid crystal, polytetrafluoroethylene, polyvinylidene fluoride, polyimide, styrene-butadiene rubber, carboxymethylcellulose, and the like, but the present invention is not limited to such examples. Usually, the content percentage of the binder in the positive electrode material is preferably not more than 10% by mass.

A method for carrying the positive electrode material on the positive electrode current collector includes for example, a method including the steps of applying the positive electrode material onto the surface of the positive electrode current collector, drying the material, and pressurizing the positive electrode current collector having a coating film of the positive electrode material in the thickness direction.

The negative electrode is an electrode which includes a negative electrode current collector and a negative electrode material, the negative electrode material being carried on the negative electrode current collector, wherein the negative electrode material includes amorphous carbon as a negative electrode active material reversibly containing sodium cation. The negative electrode material includes amorphous carbon, and if necessary, a conductive auxiliary agent and a binder.

In general, the amorphous carbon is a generic name of, for example, carbon black, activated carbon, hard carbon (non-graphitizable carbon), soft carbon (graphitizable carbon) and the like. Among the amorphous carbons, non-graphitizable carbon and graphitizable carbon are preferable. The non-graphitizable carbon is carbon which is not graphitized even by high-temperature heat treatment. The graphitizable carbon is carbon which is graphitized by high-temperature heat treatment. Preferable graphitizable carbon is graphitizable carbon which has been treated at a relatively low temperature such as a heat treatment temperature of not more than 2000° C. Among the amorphous carbons, the non-graphitizable carbon is preferable from the viewpoint of improving the charge and discharge cycle characteristics. Examples of the non-graphitizable carbon include a sintered product of a plant raw material such as wood flour; a sintered product of thermosetting resins such as phenol resin, epoxy resin and furan resin; and the like, but the present invention is not limited to such examples. Furthermore, in the present invention, for example, commercially available non-graphitizable carbon such as CARBOTRON P (trade name) manufactured by KUREHA CORPORATION can be used as the non-graphitizable carbon. Such examples of non-graphitizable carbon can be used in alone or in admixture of two or more kinds.

When the shape of the non-graphitizable carbon is particles, the average particle diameter (d₅₀) of the non-graphitizable carbon particles is preferably not less than 5 μm, more preferably not less than 70 μm from the viewpoint of suppressing the increase in the irreversible capacity of the negative electrode, and is preferably not more than 15 μm, more preferably not more than 12 μm from the viewpoint of suppressing the decrease in the utilization ratio and the rate property of the non-graphitizable carbon negative electrode. The term “average particle diameter (d₅₀)” in this specification denotes a particle diameter whose cumulative volume totalized from the smaller particle diameter side is 50% in the particle size distribution obtained according to the wet process using a laser diffraction scattering particle size distribution measurement device [manufactured by NIKKISO CO., LTD., trade name: Microtrack particle size distribution measurement device].

In the sodium secondary battery as one embodiment of the present invention, it is important to maintain the content of water in the sodium secondary battery as low as possible. By using the content of water in the molten salt electrolyte as an index for estimating the content of water in the sodium secondary battery, the content of water in the sodium secondary battery can be controlled. In the sodium secondary battery, as the content of water in the molten salt electrolyte is lower, more excellent battery performance is exhibited. However, water may be inevitably mixed into the sodium secondary battery due to the material constituting the sodium secondary battery or the manufacturing process. In the sodium secondary battery as one embodiment of the present invention, by setting the content of water in the molten salt electrolyte preferably at not more than 0.01% by mass, more preferably at not more than 0.005% by mass, the increase in the irreversible capacity of the non-graphitizable carbon negative electrode can be suppressed, so that excellent performance of the sodium secondary battery can be maintained.

The binder used in the negative electrode material is preferably a binder which does not have a halogen atom from the viewpoint of fixing the negative electrode material to the negative electrode current collector and improving the charge and discharge cycle characteristics. Examples of the binder include a polysaccharide compound such as polyamide-imide and carboxymethylcellulose, a synthetic rubber such as styrene-butadiene rubber, and the like, but the present invention is not limited to such examples. Usually, the content percentage of the binder in the negative electrode material is preferably not more than 10% by mass, more preferably 3 to 8% by mass.

The conductive auxiliary agent used in the negative electrode material is the same as the conductive auxiliary agent used in the positive electrode material. Usually, the content percentage of the conductive auxiliary agent in the negative electrode material is preferably not more than 10% by mass.

Examples of the material constituting the negative electrode current collector include aluminum, copper, nickel, and the like, but the present invention is not limited to such examples.

The shape of the negative electrode current collector, the thickness of the negative electrode current collector, and, when the shape of the negative electrode current collector is a porous body, the porosity of the porous body and the average pore diameter in the porous body are the same as the type of the positive electrode current collector, the shape of the positive electrode current collector, the thickness of the positive electrode current collector, and the porosity of the porous body and the average pore diameter in the porous body when the shape of the positive electrode current collector is the porous body.

A method for carrying the negative electrode material on the negative electrode current collector includes for example, a method including the steps of applying the negative electrode material onto the surface of the negative electrode current collector, drying the material, and pressurizing the negative electrode current collector having a coating film of the negative electrode material in the thickness direction.

Examples of materials constituting the separator include a polyolefin resin such as polyethylene and polypropylene; a fluororesin such as polytetrafluoroethylene; glass; a ceramic such as alumina and zirconia; cellulose; polyphenyl sulfide; aramid; polyamide-imide; and the like, but the present invention is not limited to such examples.

Examples of the shape of the separator include a porous body shape, a fibrous body shape, and the like, but the present invention is not limited to such examples. Among these separator shapes, a porous body shape and a fibrous body shape are preferable, and a porous body is more preferable from the viewpoint of improving the charged capacity and the discharged capacity of the sodium secondary battery.

Usually, the thickness of the separator is preferably not less than 20 μm from the viewpoint of suppressing the occurrence of internal short circuit in the sodium secondary battery, and preferably not more than 400 μm, more preferably not more than 100 μm from the viewpoint of downsizing the sodium secondary battery and improving the rate property.

Examples of the material constituting the battery case main body include stainless steel, an aluminum alloy, and the like, but the present invention is not limited to such examples.

The shape of the battery case main body cannot be uniformly determined because it is different depending upon the application of the sodium secondary battery or the like. Therefore, it is preferable that the shape be appropriately determined according to the application of the sodium secondary battery or the like.

The molten salt electrolyte is a mixture of a salt composed of sodium cation and an anion and a salt composed of an organic cation and an anion. However, sodium chloride is excluded from the salt composed of sodium cation and an anion. Since the molten salt electrolyte includes an organic cation as a cation, resistance at the time when the sodium cation is inserted into the amorphous carbon or the sodium cation is desorbed from the atomic arrangement structure of the amorphous carbon can be reduced, thus enabling the insertion of the sodium cation into the atomic arrangement structure of the amorphous carbon or desorption of the sodium cation from the atomic arrangement structure of the amorphous carbon to be carried out smoothly.

Examples of the anion include a halogen anion; an amide anion having a halogen atom or an alkyl group including a halogen atom; an anion having a halogen atom or an alkyl group including a halogen atom, such as a sulfonic acid anion having a halogen atom or an alkyl group including a halogen atom; and the like, but the present invention is not limited to such examples. These anions can be used in alone or in admixture of two or more kinds.

Examples of the halogen anion include a fluorine anion, a chlorine anion, a bromine anion, an iodine anion, and the like, but the present invention is not limited to such examples. These halogen anions can be used in alone or in admixture of two or more kinds.

Examples of the amide anion having a halogen atom or an alkyl group including a halogen atom include a sulfonyl amide anion represented by the formula (I):

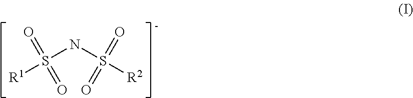

(wherein R¹ and R² each independently represent a halogen atom or an alkyl group having 1 to 10 carbon atoms and having a halogen atom), but the present invention is not limited to such examples.

In the formula (I), R¹ and R² each independently represent a halogen atom or an alkyl group having 1 to 10 carbon atoms and having a halogen atom. Examples of the halogen atom include a fluorine atom, a chlorine atom, a bromine atom, an iodine atom, and the like, but the present invention is not limited to such examples. Among these halogen atoms, a fluorine atom is preferable from the viewpoint of securing sufficient electrochemical stability. Examples of the alkyl group having 1 to 10 carbon atoms and having a halogen atom include a perfluoroalkyl group having 1 to 10 carbon atoms, such as perfluoromethyl group, perfluoroethyl group, perfluoropropyl group, perfluorobutyl group, perfluoropentyl group, perfluoroheptyl group, perfluorohexyl group, and perfluorooctyl group; a perchloroalkyl group having 1 to 10 carbon atoms, such as perchloromethyl group, perchloroethyl group, perchloropropyl group, perchlorobutyl group, perchloropentyl group, perchloroheptyl group, perchlorohexyl group, and perchlorooctyl group; a perbromoalkyl group having 1 to 10 carbon atoms, such as perbromomethyl group, perbromoethyl group, perbromopropyl group, perbromobutyl group, perbromopentyl group, perbromoheptyl group, perbromohexyl group, and perbromooctyl group; a periodoalkyl group having 1 to 10 carbon atoms, such as periodomethyl group, periodoethyl group, periodopropyl group, periodobutyl group, periodopentyl group, periodoheptyl group, periodohexyl group, and periodooctyl group; and the like, but the present invention is not limited to such examples. Among these alkyl groups having 1 to 10 carbon atoms and having a halogen atom, a perfluoroalkyl group having 1 to 10 carbon atoms is preferable, a perfluoroalkyl group having 1 to 4 carbon atoms is more preferable, and a perfluoromethyl group is further preferable because the industrial production of the molten salt electrolyte is easy. A sodium secondary battery in which the anion constituting the molten salt electrolyte is a sulfonyl amide anion represented by the formula (I) shows excellent charge and discharge cycle characteristics.

Examples of the sulfonyl amide anion represented by the formula (I) include a bis(trifluoromethyl sulfonyl)amide anion, a fluorosulfonyl(trifluoromethyl sulfonyl)amide anion, a bis(fluorosulfonyl)amide anion, and the like, but the present invention is not limited to such examples. These sulfonyl amide anions can be used in alone or in admixture of two or more kinds. Among these sulfonyl amide anions, at least one selected from the group consisting of a bis(trifluoromethyl sulfonyl)amide anion, a fluorosulfonyl(trifluoromethyl sulfonyl)amide anion and a bis(fluorosulfonyl)amide anion is preferable from the viewpoint of securing excellent charge and discharge cycle characteristics.

Examples of the sulfonic acid anion having a halogen atom or an alkyl group including a halogen atom include a sulfonic acid anion represented by the formula (II):

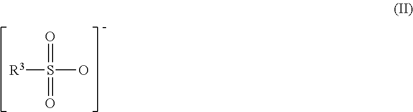

(wherein R³ represents a halogen atom or an alkyl group having 1 to 10 carbon atoms and having a halogen atom), but the present invention is not limited to such examples.

In the formula (II), R³ represent a halogen atom or an alkyl group having 1 to 10 carbon atoms and having a halogen atom. The halogen atom in the formula (II) is the same as the halogen atom in the formula (I). Furthermore, the alkyl group having 1 to 10 carbon atoms and having a halogen atom in the formula (II) is the same as the alkyl group having 1 to 10 carbon atoms and having a halogen atom in the formula (I).

Examples of the sulfonic acid anion represented by the formula (II) include a trifluoromethyl sulfonic acid anion, a fluorosulfonic acid anion, and the like, but the present invention is not limited to such examples. These sulfonic acid anions can be used in alone or in admixture of two or more kinds.

Among the above-mentioned anions, the amide anion having a halogen atom or an alkyl group including a halogen atom is preferable from the viewpoint of lowering the melting point of the molten salt electrolyte. Among the amide anions, a sulfonyl amide anion represented by the formula (I) is preferable, at least one selected from the group consisting of a bis(trifluoromethyl sulfonyl)amide anion, a fluorosulfonyl(trifluoromethyl sulfonyl)amide anion and a bis(fluorosulfonyl)amide anion is more preferable, and a bis(fluorosulfonyl)amide anion is further preferable from the viewpoint of securing excellent charge and discharge cycle characteristics.

Examples of the organic cation include organic onium cations such as a tertiary onium cation and a quaternary onium cation, but the present invention is not limited to such examples. These organic cations can be used in alone or in admixture of two or more kinds.

Examples of the tertiary onium cation include a cation represented by the formula (III):

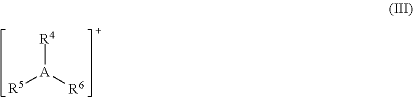

(wherein R⁴, R⁵ and R⁶ each independently represent an alkyl group having 1 to 10 carbon atoms, and A represents a sulfur atom), but the present invention is not limited to such examples.

In the formula (III), R⁴ to R⁶ each independently represent an alkyl group having 1 to 10 carbon atoms. Examples of the alkyl group having 1 to 10 carbon atoms include an alkyl group having a straight chain or a branched chain, such as methyl group, ethyl group, propyl group, isopropyl group, butyl group, isobutyl group, tert-butyl group, pentyl group, hexyl group, heptyl group, dimethyl hexyl group, trimethyl hexyl group, ethyl hexyl group, and octyl group; an alicyclic alkyl group having 1 to 10 carbon atoms, such as cyclopropyl group, cyclobutyl group, cyclopentyl group, cyclohexyl group, cycloheptyl group, and cyclooctyl group; and the like, but the present invention is not limited to such examples. Among these alkyl groups having 1 to 10 carbon atoms, dimethyl hexyl group is preferable from the viewpoint of securing sufficient electrochemical stability. Furthermore, in the formula (III), A is a sulfur atom as mentioned above.

Examples of the cation represented by the formula (III) include trialkyl sulfonium cation such as trimethyl sulfonium cation, triethyl sulfonium cation, tributyl sulfonium cation, trihexyl sulfonium cation, diethyl methyl sulfonium cation, and dibutyl ethyl sulfonium cation, but the present invention is not limited to such examples. These cations can be used in alone or in admixture of two or more kinds.

Examples of the quaternary onium cation include a cation represented by the formula (IV):

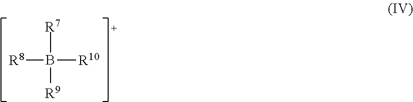

(wherein R⁷ to R¹⁰ each independently represent an alkyl group having 1 to 10 carbon atoms or an alkyloxy alkyl group having 1 to 10 carbon atoms, and B represents a nitrogen atom or a phosphorus atom); an imidazolium cation represented by the formula (V):

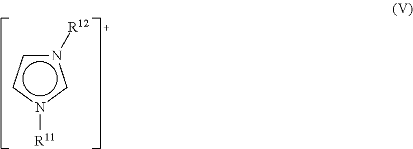

(wherein R¹¹ and R¹² each independently represent an alkyl group having 1 to 10 carbon atoms); an imidazolinium cation represented by the formula (VI):

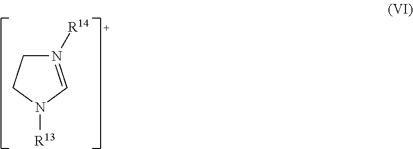

(wherein R¹³ and R¹⁴ each independently represent an alkyl group having 1 to 10 carbon atoms); a pyridinium cation represented by the formula (VII):

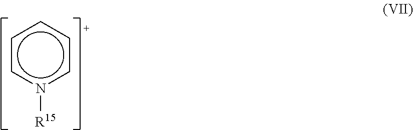

(wherein R¹⁵ represents an alkyl group having 1 to 10 carbon atoms); a cation represented by the formula (VIII):

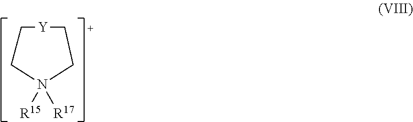

[wherein R¹⁶ and R¹⁷ each independently represent an alkyl group having 1 to 10 carbon atoms, Y represents a direct bond, an oxygen atom, methylene group, or a group represented by the formula (IX):

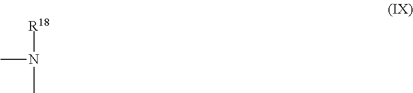

(wherein R¹⁸ represents an alkyl group having 1 to 10 carbon atoms)], and the like, but the present invention is not limited to such examples.

In the formula (IV), R⁷ to R¹⁰ each independently represent an alkyl group having 1 to 10 carbon atoms or an alkyloxy alkyl group having 1 to 10 carbon atoms. The alkyl group having 1 to 10 carbon atoms in the formula (IV) is the same as the alkyl group having 1 to 10 carbon atoms in the formula (III). Examples of the alkyloxy alkyl group having 1 to 10 carbon atoms include methoxy methyl group, 2-methoxy ethyl group, ethoxy methyl group, 2-ethoxy ethyl group, 2-(n-propoxy)ethyl group, 2-(n-isopropoxy)ethyl group, 2-(n-butoxy)ethyl group, 2-isobutoxy ethyl group, 2-(tert-butoxy)ethyl group, 1-ethyl-2-methoxy ethyl group, and the like, but the present invention is not limited to such examples.

Among these alkyl groups having 1 to 10 carbon atoms and alkyloxy alkyl groups having 1 to 10 carbon atoms, trimethyl hexyl group is preferable from the viewpoint of securing sufficient electrochemical stability. Moreover, in the formula (IV), B is a nitrogen atom or a phosphorus atom as mentioned above.

Examples of the cation represented by the formula (IV) include ammonium cations such as N,N-dimethyl-N-ethyl-N-propyl ammonium cation, N,N-dimethyl-N-ethyl-N-methoxy methyl ammonium cation, N,N-dimethyl-N-ethyl-N-methoxy ethyl ammonium cation, N,N-dimethyl-N-ethyl-N-ethoxy ethyl ammonium cation, N,N,N-trimethyl-N-propyl ammonium cation, N,N,N-trimethyl-N-butyl ammonium cation, N,N,N-trimethyl-N-pentyl ammonium cation, N,N,N-trimethyl-N-hexyl ammonium cation, N,N,N-trimethyl-N-heptyl ammonium cation, N,N,N-trimethyl-N-octyl ammonium cation, N,N,N,N-tetrabutyl ammonium cation, N,N,N,N-tetrapentyl ammonium cation, N,N,N,N-tetrahexyl ammonium cation, N,N,N,N-tetraheptyl ammonium cation, and N,N,N,N-tetra octyl ammonium cation; phosphonium cations such as triethyl(methoxy methyl)phosphonium cation, diethyl methyl(methoxy methyl)phosphonium cation, tripropyl(methoxy methyl)phosphonium cation, tributyl(methoxy methyl)phosphonium cation, tributyl(methoxy ethyl)phosphonium cation, tripentyl(methoxy methyl)phosphonium cation, tripentyl(2-methoxy ethyl)phosphonium cation, trihexyl(methoxy methyl)phosphonium cation, trihexyl(methoxy ethyl)phosphonium cation, tetramethyl phosphonium cation, tetraethyl phosphonium cation, tetrabutyl phosphonium cation, tetrapentyl phosphonium cation, tetrahexyl phosphonium cation, tetraheptyl phosphonium cation, and tetraoctyl phosphonium cation; and the like, but the present invention is not limited to such examples. These cations can be used in alone or in admixture of two or more kinds.

In the formula (V), R¹¹ and R¹² each independently represent an alkyl group having 1 to 10 carbon atoms. The alkyl group having 1 to 10 carbon atoms in the formula (V) is the same as the alkyl group having 1 to 10 carbon atoms in the formula (III).

Examples of the imidazolium cation represented by the formula (V) include 1,3-dimethyl imidazolium cation, 1-ethyl-3-methyl imidazolium cation, 1-methyl-3-propyl imidazolium cation, 1-butyl-3-methyl imidazolium cation, 1-methyl-3-pentyl imidazolium cation, 1-hexyl-3-methyl imidazolium cation, 1-heptyl-3-methyl imidazolium cation, 1-methyl-3-octyl imidazolium cation, 1-ethyl-3-propyl imidazolium cation, 1-butyl-3-ethyl imidazolium cation, and the like, but the present invention is not limited to such examples. These imidazolium cations can be used in alone or in admixture of two or more kinds.

In the formula (VI), R¹³ and R¹⁴ each independently represent an alkyl group having 1 to 10 carbon atoms. The alkyl group having 1 to 10 carbon atoms in the formula (VI) is the same as the alkyl group having 1 to 10 carbon atoms in the formula (III).

Examples of the imidazolinium cation represented by the formula (VI) include 1,3-dimethyl imidazolinium cation, 1-ethyl-3-methyl imidazolinium cation, 1-methyl-3-propyl imidazolinium cation, 1-butyl-3-methyl imidazolinium cation, 1-methyl-3-pentyl imidazolinium cation, 1-hexyl-3-methyl imidazolinium cation, 1-heptyl-3-methyl imidazolinium cation, 1-methyl-3-octyl imidazolinium cation, 1-ethyl-3-propyl imidazolinium cation, 1-butyl-3-ethyl imidazolinium cation, and the like, but the present invention is not limited to such examples.

In the formula (VII), R¹⁵ represents an alkyl group having 1 to 10 carbon atoms. The alkyl group having 1 to 10 carbon atoms in the formula (VII) is the same as the alkyl group having 1 to 10 carbon atoms in the formula (III).

Examples of the pyridinium cation represented by the formula (VII) include N-methyl pyridinium cation, N-ethyl pyridinium cation, N-propyl pyridinium cation, N-butyl pyridinium cation, N-pentyl pyridinium cation, N-hexyl pyridinium cation, N-heptyl pyridinium cation, N-octyl pyridinium cation, and the like, but the present invention is not limited to such examples. These pyridinium cations can be used in alone or in admixture of two or more kinds.

In the formula (VIII), R¹⁶ and R¹⁷ each independently represent an alkyl group having 1 to 10 carbon atoms. The alkyl group having 1 to 10 carbon atoms in the formula (VIII) is the same as the alkyl group having 1 to 10 carbon atoms in the formula (III). Furthermore, in the formula (VIII), Y represents a direct bond, an oxygen atom, methylene group, or a group represented by the formula (IX). In the formula (IX), R¹⁸ represents an alkyl group having 1 to 10 carbon atoms. The alkyl group having 1 to 10 carbon atoms in the formula (IX) is the same as the alkyl group having 1 to 10 carbon atoms in the formula (III).

In the formula (VIII), the cation in which Y is a direct bond is a pyrrolidinium cation represented by the formula (X):

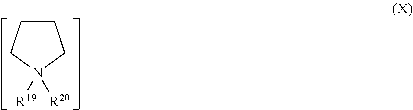

(wherein R¹⁹ and R²⁰ each independently represent an alkyl group having 1 to 10 carbon atoms).

In the formula (X), R¹⁹ and R²⁰ each independently represent an alkyl group having 1 to 10 carbon atoms. The alkyl group having 1 to 10 carbon atoms in the formula (X) is the same as the alkyl group having 1 to 10 carbon atoms in the formula (III). Examples of the pyrrolidinium cation represented by the formula (X) include N,N-dimethyl pyrrolidinium cation, N-ethyl-N-methyl pyrrolidinium cation, N-methyl-N-propyl pyrrolidinium cation, N-butyl-N-methyl pyrrolidinium cation, N-ethyl-N-butyl pyrrolidinium cation, N-methyl-N-pentyl pyrrolidinium cation, N-hexyl-N-methyl pyrrolidinium cation, N-methyl-N-octyl pyrrolidinium cation, and the like, but the present invention is not limited to such examples. These pyrrolidinium cations can be used in alone or in admixture of two or more kinds.

In the formula (VIII), a cation in which Y is an oxygen atom is a morpholinium cation represented by the formula (XI):

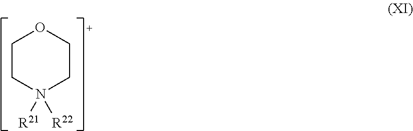

(wherein R²¹ and R²² each independently represent an alkyl group having 1 to 10 carbon atoms).

In the formula (XI), R²¹ and R²² each independently represent an alkyl group having 1 to 10 carbon atoms. The alkyl group having 1 to 10 carbon atoms in the formula (XI) is the same as the alkyl group having 1 to 10 carbon atoms in the formula (III). Examples of the morpholinium cation represented by the formula (XI) include N,N-dimethyl morpholinium cation, N-methyl-N-ethyl morpholinium cation, N-methyl-N-propyl morpholinium cation, N-methyl-N-butyl morpholinium cation, and the like, but the present invention is not limited to such examples. These morpholinium cations can be used in alone or in admixture of two or more kinds.

In the formula (VIII), the cation in which Y is a methylene group is a piperidinium cation represented by the formula (XII):

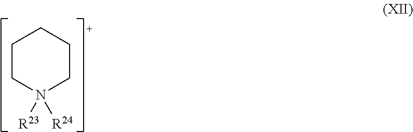

(wherein R²³ and R²⁴ each independently represent an alkyl group having 1 to 10 carbon atoms).

In the formula (XII), R²³ and R²⁴ each independently represent an alkyl group having 1 to 10 carbon atoms. The alkyl group having 1 to 10 carbon atoms in the formula (XII) is the same as the alkyl group having 1 to 10 carbon atoms in the formula (III). Examples of the piperidinium cation represented by the formula (XII) include N,N-dimethyl piperidinium cation, N-methyl-N-ethyl piperidinium cation, N-methyl-N-propyl piperidinium cation, N-butyl-N-methyl piperidinium cation, N-methyl-N-pentyl piperidinium cation, N-hexyl-N-methyl piperidinium cation, N-methyl-N-octyl piperidinium cation, and the like, but the present invention is not limited to such examples. These piperidinium cations can be used in alone or in admixture of two or more kinds.

When Y in the formula (VIII) is a group represented by the formula (IX), in the formula (IX), R¹⁸ represents an alkyl group having 1 to 10 carbon atoms. The alkyl group having 1 to 10 carbon atoms in the formula (IX) is the same as the alkyl group having 1 to 10 carbon atoms in the formula (III).

Among these organic cations, from the viewpoint of securing sufficient ionic conductivity and electrochemical stability, and carrying out a charge and discharge reaction even under low-temperature conditions, at least one selected from the group consisting of a cation represented by the formula (IV), an imidazolium cation represented by the formula (V), a pyridinium cation represented by the formula (VII), a pyrrolidinium cation represented by the formula (X), and a piperidinium cation represented by the formula (XII) is preferable, a pyrrolidinium cation represented by the formula (X) is more preferable, and at least one selected from the group consisting of N-methyl-N-propylpyrrolidinium cation and a 1-ethyl-3-methylimidazolium (EMI) cation represented by the formula (V) is further preferable.

When the molten salt electrolyte is a mixture of a salt composed of sodium cation and an anion and a salt composed of an organic cation and an anion, the amount of the sodium cation in all the cations is preferably not less than 5% by mol, more preferably not less than 8% by mol from the viewpoint of securing sufficient ionic conductivity, and is preferably not more than 50% by mol, more preferably not more than 30% by mol from the viewpoint of lowering the melting point of the molten salt electrolyte.

The molten salt electrolyte may further include metal cations other than sodium cation as long as the object of the present invention is not inhibited. Examples of the metal cations other than sodium cation include an alkali metal cation, an alkaline earth metal cation, aluminum cation, silver cation, and the like, which are cations other than sodium cation, but the present invention is not limited to such examples. Examples of the alkali metal cations other than sodium cation include lithium cation, potassium cation, rubidium cation, and the like, but the present invention is not limited to such examples. Examples of the alkaline earth metal cation include magnesium cation, calcium cation, and the like, but the present invention is not limited to such examples.

The content percentage of metal cations other than sodium cation in all the cations in the molten salt electrolyte is not more than 5% by mol, preferably not more than 4.5% by mol, more preferably not more than 4% by mol, further preferably not more than 3% by mol, still further preferably not more than 1% by mol, and particularly preferably 0% by mol from the viewpoint of improving the charged capacity and the discharged capacity as well as the charge and discharge cycle characteristics of the sodium secondary battery.

Among the molten salt electrolytes, at least one selected from the group consisting of a mixture of sodium bis(fluorosulfonyl)amide and N-methyl-N-propylpyrrolidinium bis(fluorosulfonyl)amide and a mixture of sodium bis(fluorosulfonyl)amide and 1-ethyl-3-methylimidazolium (EMI) is preferable from the viewpoint of securing the electrochemical stability and the low viscosity. The amount of sodium bis(fluorosulfonyl)amide per 1 mol of the mixture is preferably not less than 0.1 mol, more preferably not less than 0.2 mol from the viewpoint of improving the rate property when the charge and discharge reaction of the sodium secondary battery is carried out, and preferably not more than 0.5 mol, more preferably not more than 0.45 mol from the viewpoint of suppressing the increase in the viscosity of the molten salt electrolyte, suppressing the deterioration of permeability of the molten salt electrolyte in the sodium secondary battery and improving the working efficiency of an operation of filling the sodium secondary battery with an electrolytic solution at the time of manufacture of the sodium secondary battery.

The amount of the molten salt electrolyte filled into a battery case main body which contains the electrode unit cannot be uniformly determined because it is different depending upon the application of the sodium secondary battery and the size of the battery case main body. Therefore, it is preferable that the amount be appropriately determined according to the application of the sodium secondary battery and the size of the battery case main body.

The battery case main body can be sealed by caulking and fixing a gasket and a lid to the opening part of the battery case main body.

Examples of the material for forming the lid include stainless steel, an aluminum alloy, and the like, but the present invention is not limited to such examples.

The shape of the lid cannot be uniformly determined because the shape is different depending upon the shapes of the battery case main body and the gasket. Therefore, it is preferable that the shape be appropriately determined according to the shapes of the battery case main body and the gasket. The shape of the lid may be usually a shape capable of sealing by laser welding, and may be a shape capable of caulking and fixing to the opening part of the battery case main body together with the gasket.

Materials for forming the gasket are materials having heat resistance at a temperature at which the sodium secondary battery is used, and corrosion resistance and electric insulating property with respect to the molten salt electrolyte. Examples of the material for forming the gasket include a fluororesin such as polytetrafluoroethylene and a tetrafluoroethylene-perfluoroalkyl vinyl ether copolymer; an aromatic polyether ketone resin such as polyether ether ketone; fluororubber, glass, ceramics, polyphenyl sulfide, heat-resistant polyvinyl chloride, and the like, but the present invention is not limited to such examples. The thickness of the gasket is preferably not less than 0.5 mm, more preferably not less than 1 mm from the viewpoint of suppressing occurrence of the internal short circuit, and preferably not more than 5 mm, more preferably not more than 3 mm from the viewpoint of suppressing leak current. The volume resistivity of the gasket can be appropriately set as long as the leak current can be suppressed.

The shape of the gasket may be any shape as long as it can be caulked and fixed to the opening part of the battery case main body together with the lid. The shape cannot be uniformly determined because the shape is different depending upon the shapes of the battery case main body and the lid. Therefore, it is preferable that the shape be appropriately determined according to the shapes of the battery case main body and the lid.

As described above, since the sodium secondary battery as one embodiment of the present invention includes amorphous carbon as the negative electrode active material, and a molten salt electrolyte which is a mixture of a salt composed of sodium cation and an anion and a salt composed of an organic cation and an anion as an electrolyte, and, therefore, it has a high charged capacity and a high discharged capacity, and has excellent charge and discharge cycle characteristics. Therefore, the sodium secondary battery as one embodiment of the present invention is expected to be used as, for example, power sources for vehicles and an electricity storage device for electric power storage in power networks.

The embodiments disclosed in the present specification should be construed not restrictions but examples in all respects. The scope of the present invention does not have the above-mentioned meaning but shown by the claims, and all the modifications made within the scope that is equivalent to the claims and having the same meaning as the claims are intended to be encompassed by the present invention.

### EXAMPLES

Next, the present invention is described in more detail based on examples, but the present invention is not limited to the examples.

### Experimental Example 1

For the purpose of examining the performance of non-graphitizable carbon as an active material when a molten salt electrolyte is used, a half cell was fabricated by using metallic sodium as a counter electrode and non-graphitizable carbon as a positive electrode active material.

(1) Production of Positive Electrode

Non-graphitizable carbon particles [manufactured by KUREHA CORPORATION, trade name: CARBOTRON P, average particle diameter (d₅₀): 9 μm] as an active material and polyamide-imide [manufactured by NIPPON KODOSHI CORPORATION, trade name: SOXR-O] as a binder were mixed with each other so that non-graphitizable carbon/polyamide-imide (mass ratio) was 92/8, and 52 g of the obtained mixture was suspended in 48 g of N-methyl-2-pyrrolidone as a solvent, whereby a paste-like electrode material was obtained. Next, the electrode material obtained as described above was applied onto one surface of an aluminum foil by using a doctor blade so that the applied amount of the electrode material per 1 cm² of the aluminum foil (thickness: 20 μm) as a current collector was 3.6 mg and the thickness of a coating film of the electrode material was 45 μm, to form a coating film of the electrode material. Next, the aluminum foil provided with the coating film of the electrode material was dried under reduced pressure (10 Pa) at 150° C. for 24 hours, and thereafter the aluminum foil provided with the coating film of the dried electrode material was pressurized by a roller press machine (press gap: 40 μm), thereby giving a positive electrode plate (thickness: 40 μm). The obtained positive electrode plate was punched out into a disk shape having a diameter of 12 mm to obtain a disk-like positive electrode.

(2) Production of Counter Electrode

By punching out a metallic sodium foil (thickness: 700 μm) into a disk shape having a diameter of 14 mm, a disk-like counter electrode was obtained.

(3) Production of Separator

By punching out a glass non-woven fabric having a thickness of 200 μm into a disk shape having a diameter of 16 mm, a separator (diameter: 16 mm, thickness: 200 μm) was obtained.

(4) Production of Electrolyte

N-methyl-N-propylpyrrolidinium bis(fluorosulfonyl)amide (hereinafter, referred to as “P13FSA”) and sodium bis(fluorosulfonyl)amide (hereinafter, referred to as “NaFSA”) were mixed with each other so that P13FSA/NaFSA (molar ratio) was 9/1, whereby a mixed molten salt electrolyte of P13FSA and NaFSA [P13FSA/NaFSA (molar ratio): 9/1, the content percentage of sodium cations in all the cations in the electrolyte: 10% by mol, the content percentage of potassium cations in all the cations in the electrolyte: 0% by mol, and the amount of NaFSA per 1 mol of the mixture of P13FSA and NaFSA: 0.1 mol] was obtained as the electrolyte.

(5) Fabrication of Half Cell

The separator obtained in the above-mentioned (3) was impregnated with the electrolyte obtained in the above-mentioned (4). Thereafter, the positive electrode, the counter electrode and the separator were pressure-welded to one another so that the coating film of the electrode material in the positive electrode obtained in the above-mentioned (1) faced the counter electrode obtained in the above-mentioned (2) with the separator impregnated with the electrolyte interposed therebetween, thereby giving an electrode unit. Next, the obtained electrode unit was put in a coin cell case (cell size: CR2032). Thereafter, the lid of the coin cell case was closed via a gasket made of perfluoroalkoxy alkane (PFA) to seal the case, thereby giving a half cell.

### Experimental Example 2

A half cell was obtained by carrying out the same procedure as in Experimental Example 1 except that a mixed molten salt electrolyte of P13FSA, NaFSA, and KFSA [P13FSA/NaFSA/KFSA (molar ratio): 9/0.8/0.2, the content percentage of sodium cations in all the cations in the electrolyte: 8% by mol, the content percentage of potassium cations in all the cations in the electrolyte: 2% by mol] was used as an electrolyte in place of the mixed molten salt electrolyte of P13FSA and NaFSA [P13FSA/NaFSA (molar ratio): 9/1, the content percentage of sodium cations in all the cations in the electrolyte: 10% by mol, the content percentage of potassium cations in all the cations in the electrolyte: 0% by mol, and the amount of NaFSA per 1 mol of the mixture of P13FSA and NaFSA: 0.1 mol] in Experimental Example 1.

### Experimental Example 3

A half cell was obtained by carrying out the same procedure as in Experimental Example 1 except that a mixed molten salt electrolyte of P13FSA and potassium bis(fluorosulfonyl)amide (hereinafter, referred to as “KFSA”) [P13FSA/KFSA (molar ratio): 9/1, the content percentage of potassium cations in all the cations in the electrolyte: 10% by mol] was used as an electrolyte in place of the mixed molten salt electrolyte of P13FSA and NaFSA [P13FSA/NaFSA (molar ratio): 9/1, the content percentage of sodium cations in all the cations in the electrolyte: 10% by mol, the content percentage of potassium cations in all the cations in the electrolyte: 0% by mol, and the amount of NaFSA per 1 mol of the mixture of P13FSA and NaFSA: 0.1 mol] in Experimental Example 1.

### Test Example 1

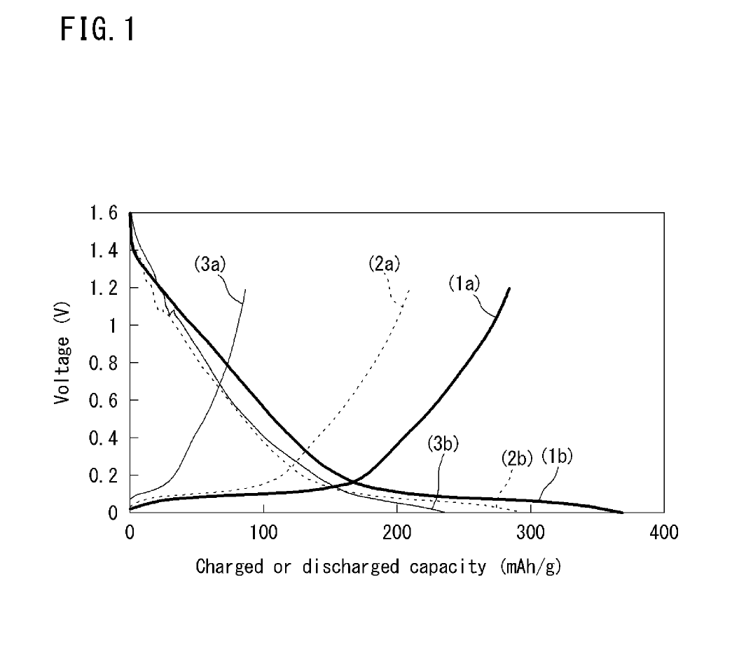

The half cells obtained in Experimental Examples 1 to 3 were heated to 90° C., respectively, and thereafter each of the half cells obtained in Experimental Examples 1 to 3 was charged and discharged repeatedly at a current value of 25 mA/g. The voltage, charged capacity and discharged capacity of each of the half cells obtained in Experimental Examples 1 to 3 after the first cycle of charge and discharge was carried out were obtained. Furthermore, as to each of the half cells obtained in Experimental Examples 1 to 3, the discharged capacity in the voltage range of 0 to 1.2 V was examined for each cycle of charge and discharge. In Test Example 1, charge/discharge curves of the half cells obtained in Experimental Examples 1 to 3 are shown in FIG. 1. In FIG. 1, (1a) represents the relation between the charged capacity and the voltage of the half cell obtained in Experimental Example 1, (1b) represents the relation between the discharged capacity and the voltage of the half cell obtained in Experimental Example 1, (2a) represents the relation between the charged capacity and the voltage of the half cell obtained in Experimental Example 2, (2b) represents the relation between the discharged capacity and the voltage of the half cell obtained in Experimental Example 2, (3a) represents the relation between the charged capacity and the voltage of the half cell obtained in Experimental Example 3, and (3b) represents the relation between the discharged capacity and the voltage of the half cell obtained in Experimental Example 3. In this experiment, note that discharge is a reaction in which sodium cation is inserted into the atomic arrangement structure of non-graphitizable carbon, and charge is a reaction in which sodium cation is desorbed from the atomic arrangement structure of non-graphitizable carbon.

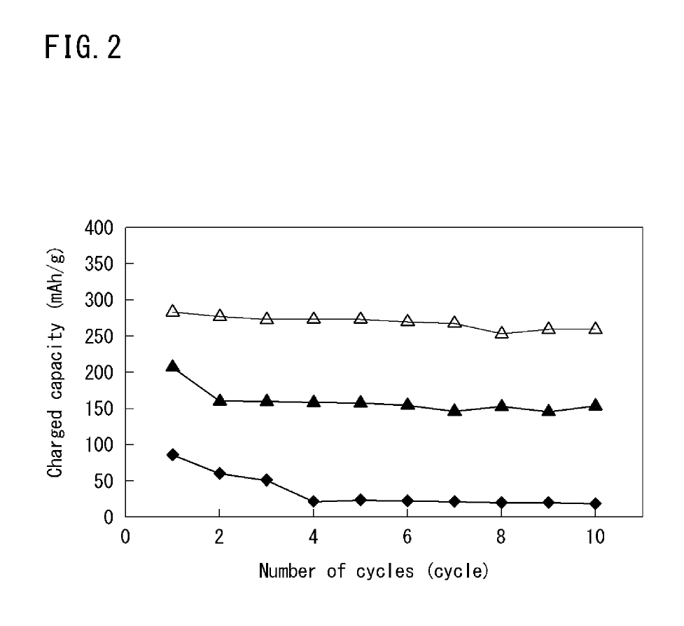

Furthermore, FIG. 2 shows the results of examining in Test Example 1, the relation between the number of cycles and the charged capacity in each of the half cells obtained in Experimental Examples 1 to 3. In FIG. 2, open triangles represent the relation between the number of cycles and the charged capacity of the half cell obtained in Experimental Example 1, closed triangles represent the relation between the number of cycles and the charged capacity of the half cell obtained in Experimental Example 2, and closed rectangles being the relation between the number of cycles and the charged capacity of the half cell obtained in Experimental Example 3.

From the results shown in FIG. 1, it can be seen that the half cell obtained by using the mixed molten salt electrolyte of P13FSA and NaFSA as an electrolyte (Experimental Example 1) has a larger charged capacity and a larger discharged capacity as compared with the half cell obtained by using the mixed molten salt electrolyte of P13FSA and KFSA as an electrolyte (Experimental Example 3). Furthermore, from the results shown in FIG. 2, it can be seen that, in the half cell in which the content percentage of potassium cations in all the cations in the electrolyte is more than 5% by mol (Experimental Example 3), the capacity in the fourth to fifth cycles from the start of charge and discharge is reduced to less than 30% of the charged capacity after one cycle of charge and discharge is carried out (hereinafter, referred to as “initial capacity”), and in the half cell in which the content percentage of potassium cations in all the cations in the electrolyte is not more than 5% by mol (Experimental Examples 1 and 2), the change of the capacity is smaller than that of the half cell in which the content percentage of potassium cations in all the cations in the electrolyte is more than 5% by mol (Experimental Example 3) even after the repeated charge and discharge.

From these results, it can be seen that the charge and discharge cycle characteristics can be improved by using, in a sodium secondary battery including an electrolyte including sodium cation, a molten salt electrolyte including sodium cation and having the content percentage of potassium cations in all the cations in the electrolyte of not more than 5% by mol as the electrolyte including sodium cation.

### Experimental Example 4

A half cell was obtained by carrying out the same procedure as in Experimental Example 1 except that polyvinylidene fluoride [manufactured by KUREHA CORPORATION, trade name: KF polymer] was used as a binder of the electrode material in place of polyamide-imide in Experimental Example 1.

### Test Example 2

The half cells obtained in Experimental Examples 1 and 4 were heated to 90° C., respectively, and thereafter each of the half cells obtained in Experimental Examples 1 and 4 was charged and discharged repeatedly at a current value of 25 mA/g. In each of the half cells obtained in Experimental Examples 1 and 4, the charged capacity in the voltage range of 0 to 1.2 V was examined for each cycle of charge and discharge. The capacity retention rate was obtained according to the formula:

[[(charged capacity of each cycle)/(initial capacity)]×100].

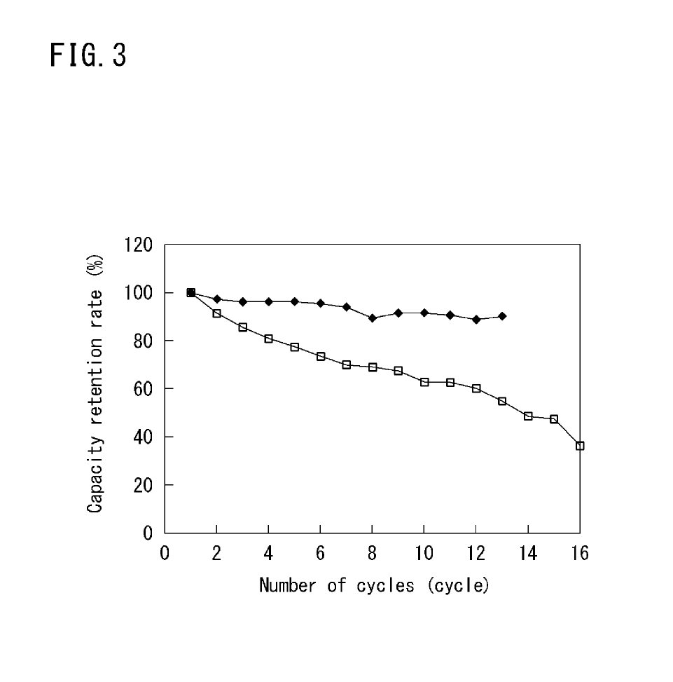

Furthermore, the voltage and the electric capacity in the first, third, fifth and tenth cycles of charge and discharge of the half cell obtained in Experimental Example 1 were obtained. FIG. 3 shows the results of examining, in Test Example 2, the relation between the number of cycles and the capacity retention rate of each of the half cells obtained in Experimental Examples 1 and 4. In FIG. 3, closed rectangles represent the relation between the number of cycles and the capacity retention rate of the half cell obtained in Experimental Example 1, and open squares represent the relation between the number of cycles and the capacity retention rate of the half cell obtained in Experimental Example 4.

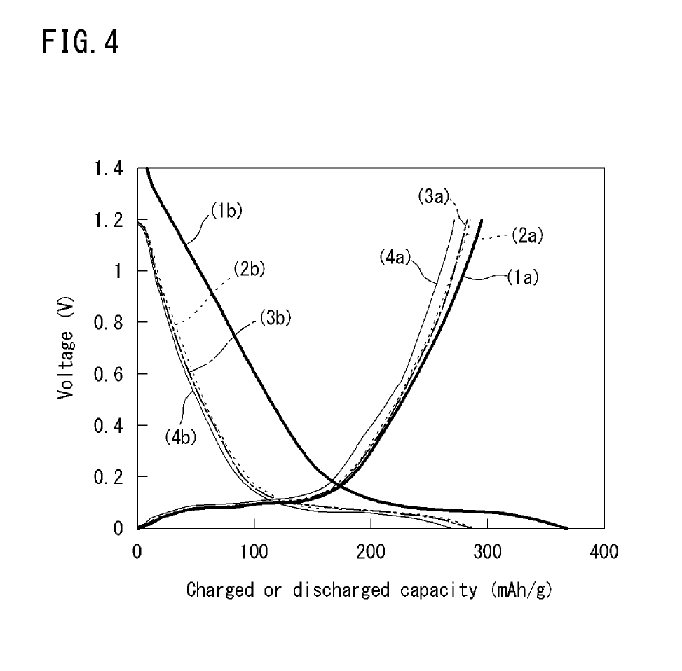

Furthermore, in Test Example 2, charge/discharge curves of the half cells obtained in Experimental Example 1 are shown in FIG. 4. In FIG. 4, (1a) represents the relation between the charged capacity and the voltage after the first cycle of charge and discharge was carried out, (1b) being the relation between the discharged capacity and the voltage after the first cycle of charge and discharge was carried out, (2a) being the relation between the charged capacity and the voltage after the third cycle of charge and discharge was carried out, (2b) being the relation between the discharged capacity and the voltage after the third cycle of charge and discharge was carried out, (3a) being the relation between the charged capacity and the voltage after the fifth cycle of charge and discharge was carried out, (3b) being the relation between the discharged capacity and the voltage after the fifth cycle of charge and discharge was carried out, (4a) being the relation between the charged capacity and the voltage after the tenth cycle of charge and discharge was carried out, and (4b) being the relation between the discharged capacity and the voltage after the tenth cycle of charge and discharge was carried out.

From the results shown in FIG. 3, in the half cell in which polyvinylidene fluoride is used as a binder of the electrode material (Experimental Example 4), it can be seen that the capacity retention rate in the thirteenth cycle from the start of the charge and discharge is less than 60%, and that the capacity retention rate is remarkably deteriorated as the number of cycles of charge and discharge is increased. A fluorine atom contained in polyvinylidene fluoride is an atom having high reactivity with metallic sodium. Therefore, it seems that since the binder is deteriorated and the active material is exfoliated from the current collector during charge and discharge in the half cell in which polyvinylidene fluoride is used as a binder of the electrode material (Experimental Example 4), the capacity retention rate is remarkably deteriorated as the number of cycles of charge and discharge is increased. On the contrary, from the results shown in FIGS. 3 and 4, it can be seen that the cycle properties are not so changed even if the number of cycles of charge and discharge is increased in the half cell in which polyamide-imide is used as a binder of the electrode material (Experimental Example 1), and that a capacity retention rate of not less than 85% is secured. Therefore, these results show that, in a sodium secondary battery including an electrolyte containing sodium cation, the charge and discharge cycle characteristics can be improved by using a molten salt electrolyte containing sodium cations and whose content percentage of potassium cations in all the cations is not more than 5% by mol as the electrolyte containing sodium cations, and using a binder which does not contain halogen atoms such as a fluorine atom as a binder to be used for the electrode material.

### Experimental Example 5

A half cell was obtained by carrying out the same procedure as in Experimental Example except that the positive electrode obtained in Experimental Example 1 (1) was left standing still in the air for 24 hours before the half cell was fabricated in Experimental Example 1.

### Experimental Example 6

A half cell was obtained by carrying out the same procedure as in Experimental Example except that the positive electrode obtained in Experimental Example 1 (1) was left standing still in the air for 24 hours and then the electrode material of the positive electrode was dried under reduced pressure (10 Pa) at 90° C. for 4 hours to remove water before a half cell was fabricated in Experimental Example 1.

### Test Example 3

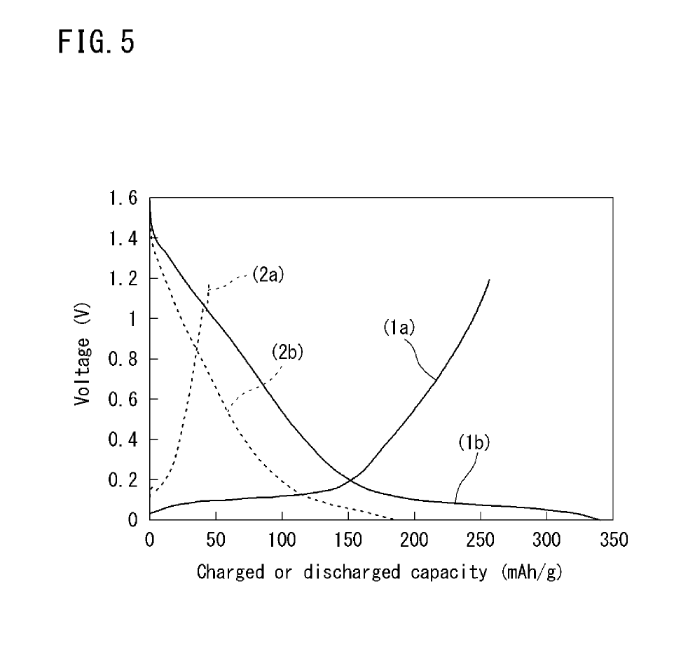

The half cells obtained in Experimental Examples 5 and 6 were heated to 90° C., respectively, and thereafter each of the half cells obtained in Experimental Examples 5 and 6 was charged and discharged repeatedly at a current value of 25 mA/g. Furthermore, the voltage and electric capacity of each of the half cells obtained in Experimental Examples 5 and 6 after the first cycle of charge and discharge was carried out were obtained. The charge/discharge curves of the half cells obtained in Experimental Examples 5 and 6 in Test Example 3 are shown in FIG. 5, respectively. In FIG. 5, (1a) represents the relation between the charged capacity and the voltage of the half cell obtained in Experimental Example 5, (1b) being the relation between the discharged capacity and the voltage of the half cell obtained in Experimental Example 5, (2a) being the relation between the charged capacity and the voltage of the half cell obtained in Experimental Example 6, and (2b) being the relation between the discharged capacity and the voltage of the half cell obtained in Experimental Example 6.

From the results shown in FIG. 5, it can be seen that the charged capacity is not less than 250 in the half cell obtained by using the positive electrode which was left standing still in the air and dried to remove water from the electrode material of the positive electrode (Experimental Example 6), whereas the charged capacity is less than 50 in the half cell obtained by using the positive electrode which was not dried after it was left standing still in the air (Experimental Example 5). These results show that the capacity can be improved by removing the water from the electrode material before the sodium secondary battery is fabricated.

### Experimental Example 7

### (1) Production of Positive Electrode

Non-graphitizable carbon particles [manufactured by KUREHA CORPORATION, trade name: CARBOTRON P, average particle diameter (d₅₀): 9 μm] as an active material and carboxymethylcellulose [manufactured by Wako Pure Chemical Industries, Ltd.] as a binder were mixed with each other so that non-graphitizable carbon/carboxymethylcellulose (mass ratio) was 93/7, and 33 g of the obtained mixture was suspended in 67 g of pure water as a solvent, thereby giving a paste-like electrode material. Next, the obtained electrode material was applied onto one surface of an aluminum foil by using a doctor blade so that the applied amount of the electrode material per 1 cm² of the aluminum foil (thickness: 20 μm) as a current collector was 3.6 mg and the thickness of a coating film of the electrode material was 45 μm, to form a coating film of the electrode material. Next, the aluminum foil provided with the coating film of the electrode material was dried under reduced pressure at 150° C. for 24 hours. Then, the aluminum foil provided with the coating film of the dried electrode material was pressurized by a roller press machine (press gap: 40 μm), thereby giving a positive electrode plate (thickness: 40 μm). The obtained positive electrode plate was punched out into a disk shape having a diameter of 12 mm to obtain a disk-like positive electrode. The obtained positive electrode was dried under reduced pressure (20 Pa) at 90° C. for 4 hours.

### (2) Production of Counter Electrode

By punching out a metallic sodium foil (thickness: 700 μm) into a disk shape having a diameter of 14 mm, a disk-like counter electrode was obtained.

### (3) Production of Separator

By punching out a glass non-woven fabric having a thickness of 200 μm into a disk shape having a diameter of 16 mm, a separator (diameter: 16 mm, thickness: 200 μm) was obtained.

### (4) Production of Electrolyte

P13FSA and NaFSA were mixed with each other so that P13FSA/NaFSA (molar ratio) was 9/1, thereby giving a mixed molten salt electrolyte of P13FSA and NaFSA [P13FSA/NaFSA (molar ratio): 9/1, the content percentage of sodium cations in all the cations in the electrolyte: 10% by mol, and the content percentage of potassium cations in all the cations in the electrolyte: 0% by mol].

### (5) Fabrication of Half Cell

The separator obtained in the above-mentioned (3) was impregnated with the electrolyte obtained in the above-mentioned (4). Thereafter, the positive electrode, the counter electrode and the separator were pressure-welded to one another so that the coating film of the electrode material in the positive electrode obtained in the above-mentioned (1) faced the counter electrode obtained in the above-mentioned (2) with the separator impregnated with the electrolyte interposed therebetween, thereby giving an electrode unit. Next, the obtained electrode unit was put in a coin cell case (cell size: CR2032). Thereafter, the lid of the coin cell case was closed via a gasket made of perfluoroalkoxy alkane (PFA) to seal the case. Thus, a half cell was obtained.

### Test Example 4

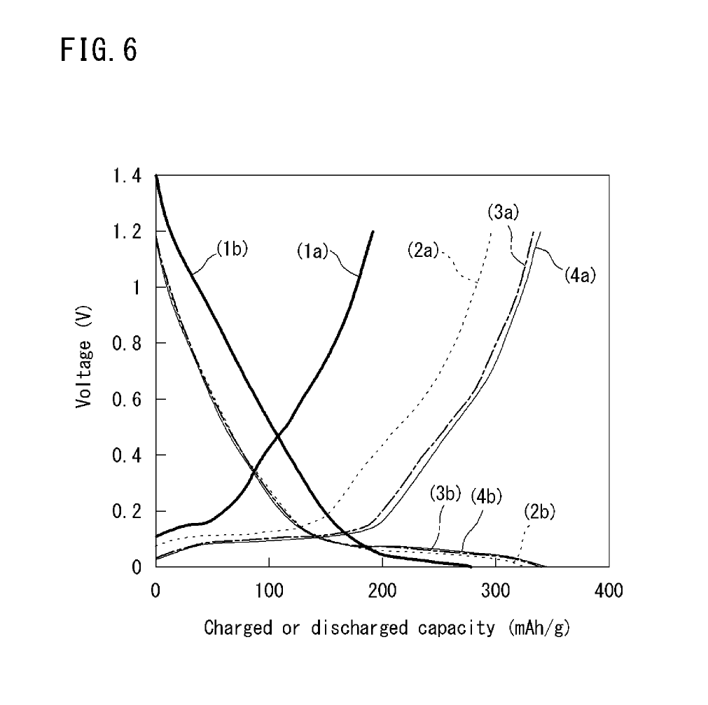

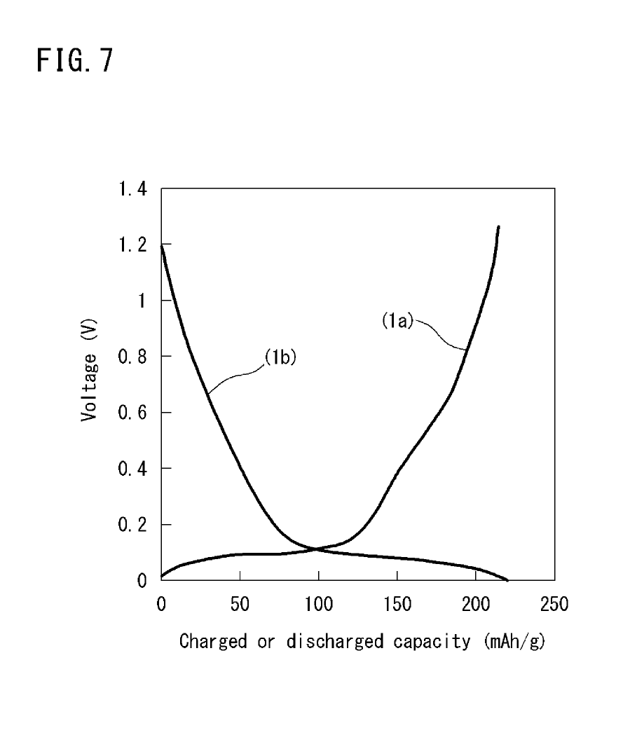

The half cell obtained in Experimental Example 7 was heated to 90° C., and thereafter charge and discharge of the half cell obtained in Experimental Example 7 was carried out repeatedly at a current value of 25 mA/g. The voltage and electric capacity of the half cell obtained in Experimental Example 7 after the first, third, fifth and tenth cycles of charge and discharge were carried out were obtained. Furthermore, the charged capacity and the discharged capacity as well as Coulomb efficiency in a voltage range of 0 to 1.2 V of the half cell obtained in Experimental Example 7 were obtained for each cycle of charge and discharge. In Test Example 4, charge/discharge curves of the half cell obtained in Experimental Example 7 are shown in FIGS. 6 and 7. In FIG. 6, (1a) represents the relation between the charged capacity and the voltage after the first cycle of charge and discharge was carried out, (1b) being the relation between the discharged capacity and the voltage after the first cycle of charge and discharge was carried out, (2a) being the relation between the charged capacity and the voltage after the third cycle of charge and discharge was carried out, (2b) being the relation between the discharged capacity and the voltage after the third cycle of charge and discharge was carried out, (3a) being the relation between the charged capacity and the voltage after the fifth cycle of charge and discharge was carried out, (3b) being the relation between the discharged capacity and the voltage after the fifth cycle of charge and discharge was carried out, (4a) being the relation between the charged capacity and the voltage after the tenth cycle of charge and discharge was carried out, and (4b) being the relation between the discharged capacity and the voltage after the tenth cycle of charge and discharge was carried out. Furthermore, in FIG. 7, (1a) represents the relation between the charged capacity and the voltage after each of the tenth to twenty fifth cycles of charge and discharge was carried out, and (1b) represents the relation between the discharged capacity and the voltage after each of the tenth to twenty fifth cycles of charge and discharge was carried out.

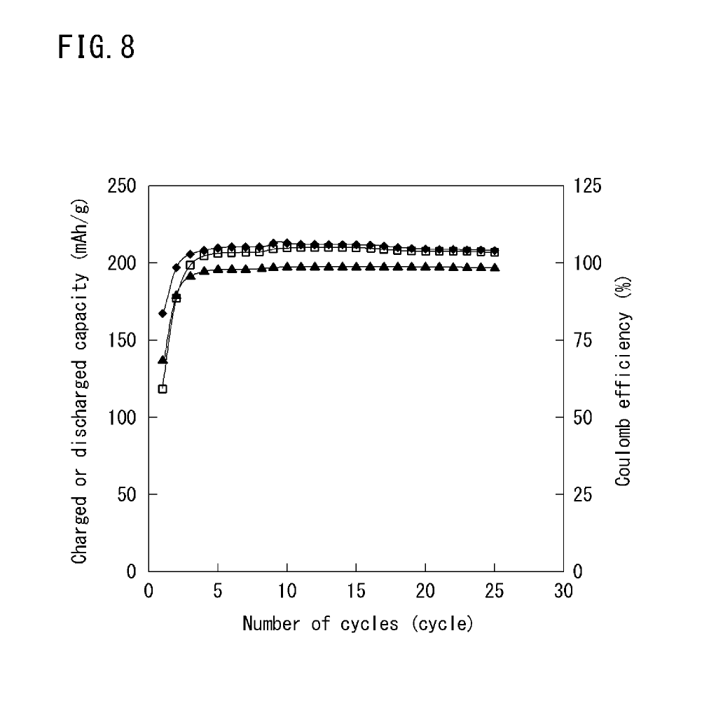

Furthermore, the results of examining in Test Example 4, the relation among the number of cycles, the charged capacity, the discharged capacity and the Coulomb efficiency was examined are shown in FIG. 8. In FIG. 8, closed rectangles represent the relation between the number of cycles and the charged capacity, open squares being the relation between the number of cycles and the discharged capacity, and closed triangles being the relation between the number of cycles and the Coulomb efficiency.

From the results shown in FIGS. 6 and 7, it can be seen that the charge/discharge curves of the tenth cycle or later after the start of the charge and discharge are almost overlapped, and that the discharged capacity and the charged capacity are kept at about 210 mAh/g. Furthermore, from the results shown in FIG. 8, it can be seen that the Coulomb efficiency of the tenth cycle or later after the start of charge and discharge is kept at about 93.3%. From these results, it can be seen that a half cell obtained by using carboxymethylcellulose as a binder of the electrode material (Experimental Example 7) has a high electric capacity and excellent cycle properties.

### Example 1

### (1) Production of Positive Electrode

Sodium chromite as an active material, acetylene black [manufactured by DENKI KAGAKU KOGYO KABUSHIKI KAISHA, trade name: DENKA BLACK] as a conductive auxiliary agent, and polyvinylidene fluoride [manufactured by KUREHA CORPORATION, trade name: KF polymer] as a binder were mixed with one another so that sodium chromite/acetylene black/polyvinylidene fluoride (mass ratio) was 85/10/5, and 57 g of the obtained mixture was suspended in 43 g of N-methyl-2-pyrrolidone as a solvent, thereby giving a paste-like electrode material. Next, the obtained positive electrode material was applied onto one surface of an aluminum foil by using a doctor blade so that the applied amount of the positive electrode material per 1 cm² of the aluminum foil (thickness: 20 μm) as a current collector was 15.3 mg and the thickness of a coating film of the positive electrode material was 80 μm to form a coating film of the positive electrode material. Next, the aluminum foil provided with the coating film of the positive electrode material was dried under reduced pressure at 150° C. for 24 hours. Next, the aluminum foil provided with the coating film of the dried positive electrode material was pressurized by a roller press machine (press gap: 65 μm), and thus a positive electrode plate (thickness: 65 μm) was obtained.

### (2) Production of Negative Electrode

Non-graphitizable carbon particles [manufactured by KUREHA CORPORATION, trade name: CARBOTRON P, average particle diameter (d₅₀): 9 μm] as an active material and polyamide-imide as a binder were mixed with each other so that non-graphitizable carbon/polyamide-imide (mass ratio) was 92/8, and thereafter 57 g of the obtained mixture was suspended in 43 g of N-methyl-2-pyrrolidone as a solvent, thereby giving a paste-like negative electrode material. Next, the obtained negative electrode material was applied onto one surface of the aluminum foil by using a doctor blade so that the applied amount of the negative electrode material per 1 cm² of the aluminum foil (thickness: 20 μm) as the current collector was 3.3 mg and the thickness of a coating film of the negative electrode material was 100 μm, to form a coating film of the negative electrode material. Next, the aluminum foil provided with the coating film of the negative electrode material was dried under reduced pressure at 150° C. for 24 hours. Then, the aluminum foil provided with the coating film of the dried negative electrode was pressurized by a roller press machine (press gap: 80 μm), thereby giving a negative electrode plate (thickness: 80 μm). By punching out the obtained negative electrode plate into a disk shape having a diameter of 12 mm, a disk-like negative electrode was obtained. The obtained negative electrode was dried under reduced pressure (20 Pa) at 90° C. for 4 hours.

### (3) Production of Separator

By punching out a glass non-woven fabric having a thickness of 200 μm into a disk shape having a diameter of 16 mm, a separator (diameter: 16 mm, thickness: 200 μm) was obtained.

### (4) Production of Electrolyte

P13FSA and NaFSA were mixed with each other so that P13FSA/NaFSA (molar ratio) was 9/1, thereby giving a mixed molten salt electrolyte of P13FSA and NaFSA [P13FSA/NaFSA (molar ratio): 9/1, the content percentage of sodium cations in all the cations in the electrolyte: 10% by mol, the content percentage of potassium cations in all the cations in the electrolyte: 0% by mol, and the amount of NaFSA per 1 mol of the mixture of P13FSA and NaFSA: 0.1 mol] as the electrolyte.

### (5) Fabrication of Sodium Secondary Battery

The separator obtained in the above-mentioned (3) was impregnated with the electrolyte obtained in the above-mentioned (4). Thereafter, the positive electrode, the negative electrode and the separator were pressure-welded to one another so that the coating film of the positive electrode material in the positive electrode obtained in the above-mentioned (1) faced the coating film of the negative electrode material in the negative electrode obtained in the above-mentioned (2) with the separator impregnated with the electrolyte interposed therebetween, thereby giving an electrode unit. Next, the obtained electrode unit was put in a coin cell case (cell size: 2032). Thereafter, the lid of the coin cell case was closed via a gasket made of perfluoroalkoxy alkane (PFA) to seal the case, thereby giving a sodium secondary battery.

### Test Example 5

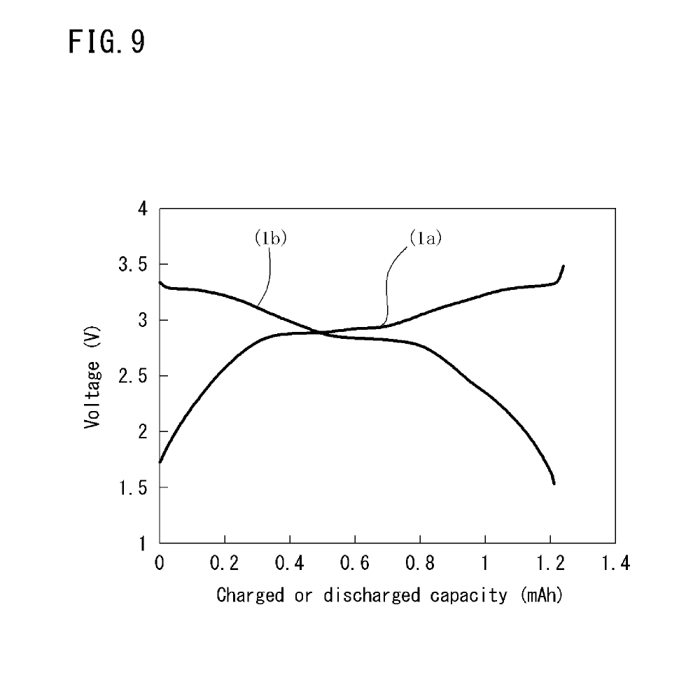

The sodium secondary battery obtained in Example 1 was heated to 90° C., and thereafter the sodium secondary battery obtained in Example 1 was charged and discharged repeatedly at a current value of 25 mA/g. The voltage and electric capacity of the sodium secondary battery obtained in Example 1 after the first cycle of charge and discharge was carried out were obtained. Furthermore, as to the sodium secondary battery obtained in Example 1, the charged capacity and the discharged capacity in the voltage range of 1.5 to 3.5 V were examined for each cycle of charge and discharge. In Test Example 5, charge/discharge curves of the sodium secondary battery obtained in Example 1 are shown in FIG. 9. In FIG. 9, (1a) represents the relation between the charged capacity and the voltage of the sodium secondary battery obtained in Example 1, and (1b) being the relation between the discharged capacity and the voltage of the sodium secondary battery obtained in Example 1.

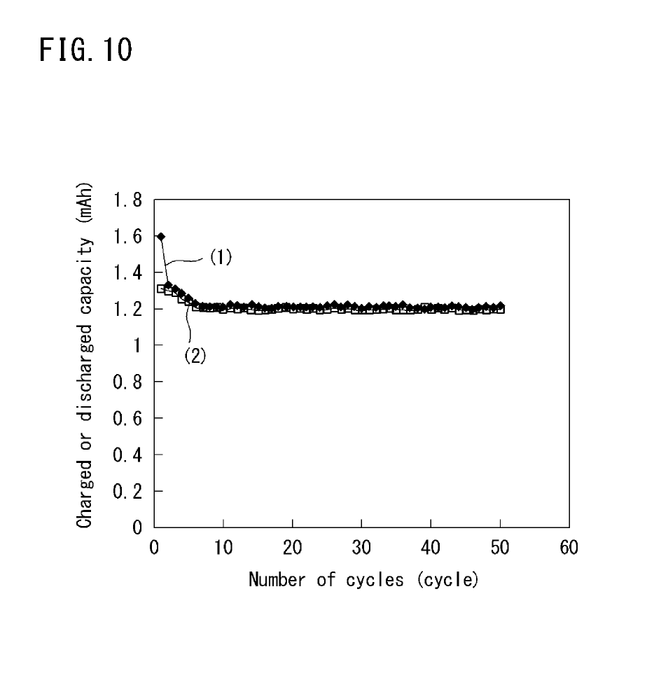

Furthermore, results of examining in Test Example 5, the relation among the number of cycles, the charged capacity and the discharged capacity are shown in FIG. 10. FIG. 10 shows (1) the relation between the number of cycles and the charged capacity, and (2) the relation between the number of cycles and the discharged capacity.

From the results shown in FIGS. 9 and 10, it can be seen that the charged capacity and the discharged capacity after one cycle of charge and discharge is carried out are 1.6 mAh and 1.3 mAh, respectively, and that the charged capacity and the discharged capacity are kept at about 1.2 mAh in the tenth cycle or later from the start of the charge and discharge.

From the above-mentioned results, it can be seen that the high charged capacity and the high discharged capacity can be secured, and the charge and discharge cycle characteristics can be improved by using in the sodium secondary battery including an electrolyte containing sodium cation, as an electrolyte a molten salt electrolyte which is a mixture of a salt composed of sodium cation and an anion and a salt composed of an organic cation and an anion, and whose content percentage of potassium cations in all the cations is not more than 5% by mol, and using a binder which does not contain halogen atoms such as a fluorine atom as a binder used for a negative electrode material.

### Example 2

P13FSA and NaFSA were mixed with each other so that P13FSA/NaFSA (molar ratio) was 9/1, thereby giving a mixed molten salt electrolyte of P13FSA and NaFSA [P13FSA/NaFSA (molar ratio): 9/1, the content percentage of sodium cations in all the cations in the electrolyte: 10% by mol, and the amount of NaFSA per 1 mol of the mixture of P13FSA and NaFSA: 0.1 mol] as the electrolyte. A sodium secondary battery was obtained by the same procedure as in Example 1 except that the electrolyte was changed to the mixed molten salt electrolyte obtained above in Example 1.

### Example 3

P13FSA and NaFSA were mixed with each other so that P13FSA/NaFSA (molar ratio) was 8/2, thereby giving a mixed molten salt electrolyte of P13FSA and NaFSA [P13FSA/NaFSA (molar ratio): 8/2, the content percentage of sodium cations in all the cations in the electrolyte: 20% by mol, and the amount of NaFSA per 1 mol of the mixture of P13FSA and NaFSA: 0.2 mol] as the electrolyte. A sodium secondary battery was obtained by the same procedure as in Example 1 except that the electrolyte was changed to the mixed molten salt electrolyte obtained above in Example 1.

### Example 4

P13FSA and NaFSA were mixed with each other so that P13FSA/NaFSA (molar ratio) was 7/3, thereby giving a mixed molten salt electrolyte of P13FSA and NaFSA [P13FSA/NaFSA (molar ratio): 7/3, the content percentage of sodium cations in all the cations in the electrolyte: 30% by mol, and the amount of NaFSA per 1 mol of the mixture of P13FSA and NaFSA: 0.3 mol] as the electrolyte. A sodium secondary battery was obtained by the same procedure as in Example 1 except that the electrolyte was changed to the mixed molten salt electrolyte obtained above in Example 1.

### Example 5

P13FSA and NaFSA were mixed with each other so that P13FSA/NaFSA (molar ratio) was 6/4, thereby giving a mixed molten salt electrolyte of P13FSA and NaFSA [P13FSA/NaFSA (molar ratio): 6/4, the content percentage of sodium cations in all the cations in the electrolyte: 40% by mol, and the amount of NaFSA per 1 mol of the mixture of P13FSA and NaFSA: 0.4 mol] as the electrolyte. A sodium secondary battery was obtained by the same procedure as in Example 1 except that the electrolyte was changed to the mixed molten salt electrolyte obtained above in Example 1.

### Example 6

P13FSA and NaFSA were mixed with each other so that P13FSA/NaFSA (molar ratio) was 5/5, thereby giving a mixed molten salt electrolyte of P13FSA and NaFSA [P13FSA/NaFSA (molar ratio): 5/5, the content percentage of sodium cations in all the cations in the electrolyte: 50% by mol, and the amount of NaFSA per 1 mol of the mixture of P13FSA and NaFSA: 0.5 mol] as the electrolyte. A sodium secondary battery was obtained by the same procedure as in Example 1 except that the electrolyte was changed to the mixed molten salt electrolyte obtained above in Example 1.

### Test Example 6

The sodium secondary batteries obtained in Examples 2 to 6 were heated to 60° C. or 90° C., and thereafter a charge and discharge test was carried out at a charge rate: a current value of 0.2 C rate, at a discharge rate: a current value of 0.2 rate, and in a voltage range of 1.5 to 3.5 V. As a result, the battery discharged capacity in the initial cycle when the charge and discharge test was carried out at 60° C. and the battery discharged capacity in the initial cycle when the charge and discharge test was carried out at 90° C. showed a substantially constant value in any of the mixed molten salt electrolytes obtained in Examples 2 to 6.

Next, the sodium secondary batteries obtained in Examples 2 to 6 were heated to 60° C., and a charge and discharge test was carried out at a charge rate: a current value of 0.2 C rate, at a discharge rate: a current value of 1 C rate, 2 C rate, or 4 C rate, and in a voltage range of 1.5 to 3.5 V. The discharged capacity ratio (%) at each discharge rate was obtained. The discharged capacity ratio (%) at each discharge rate was calculated based on the discharged capacity at 0.2 C defined as 100%. The results are shown in Table 1.

Furthermore, the sodium secondary batteries obtained in Examples 2 to 6 were heated to 90° C., and thereafter a charge and discharge test was carried out at a charge rate: a current value of 0.2 C rate, at a discharge rate: a current value of 1 C rate, 2 C rate, 4 C rate or 6 C rate, and in a voltage range of 1.5 to 3.5 V. The discharged capacity ratio (%) at each discharge rate was obtained. The discharged capacity ratio (%) at each discharge rate was calculated based on the discharged capacity at 0.2 C defined as 100%. The results are shown in Table 2.

TABLE 1

| | Discharged capacity ratio (%) at each | | | |
|---|---|---|---|---|
| Composition | discharge rate at 60° C. | | | |
| P13FSA/ | Discharge | Discharge | Discharge | Discharge |
| NaFSA | rate | rate | rate | rate |
| (molar ratio) | 0.2 C | 1 C | 2 C | 4 C |
| 5/5 | 100 | 96.6 | 82.3 | 54.2 |
| 6/4 | 100 | 96.6 | 83.2 | 46 9 |
| 7/3 | 100 | 97.3 | 65.1 | — |
| 8/2 | 100 | 93.7 | 41 | — |
| 9/1 | 100 | 37.3 | — | — |

TABLE 2

| | Discharged capacity ratio (%) at each | | | | |
|---|---|---|---|---|---|
| Composition | discharge rate at 90° C. | | | | |
| P13FSA/ | Discharge | Discharge | Discharge | Discharge | Discharge |
| NaFSA | rate | rate | rate | rate | rate |
| (molar ratio) | 0.2 C | 1 C | 2 C | 4 C | 6 C |
| 5/5 | 100 | 97.9 | 96.5 | 93.6 | 73.7 |
| 6/4 | 100 | 97.8 | 95.7 | 90.4 | 67.5 |
| 7/3 | 100 | 97.8 | 95.2 | 69.8 | 30.1 |
| 8/2 | 100 | 98.4 | 92.2 | 40.8 | — |
| 9/1 | 100 | 85 | 33.8 | — | — |

From the results shown in Tables 1 and 2, it can be seen that the higher the concentration of sodium in the electrolyte is, the larger the discharged capacity ratio is, both in the cases where the sodium secondary batteries obtained in Examples 2 to 6 were heated to 60° C. and 90° C., showing that the discharge rate property is improved. The sodium secondary batteries obtained in Examples 2 to 6 exhibited relatively stable performance also in a usual cycle lifetime test.

Furthermore, from these results, it can be seen that the mixed molten salt electrolyte of NaFSA and P13FSA exhibits excellent performance as a molten salt electrolyte when the amount of NaFSA per 1 mol of the mixture of P13FSA and NaFSA is 0.1 to 0.55 mol.

When the same experiment was carried out by using a mixed molten salt electrolyte obtained by mixing NaFSA and P13FSA so that the sodium concentration was more than 60% by mol (the amount of NaFSA per 1 mol of the mixture of P13FSA and NaFSA was 0.6 mol), the viscosity of the molten salt electrolyte increased as the sodium concentration in the electrolyte increased, and the permeability of the electrolytic solution or workability in filling the electrolytic solution in manufacturing the battery tended to deteriorate. Furthermore, when the sodium concentration was more than 56% by mol, the electrolyte became solid at room temperature (25° C.)

From these results, it is suggested that a molten salt electrolyte in which the amount of NaFSA per 1 mol of the mixture of P13FSA and NaFSA is 0.1 to 0.55 mol, preferably 0.35 to 0.45 mol satisfies both the charge and discharge performance and the viscosity.

### Experimental Examples 8 to 10

A half cell was obtained by carrying out the same procedure as in Experimental Example 1 except that non-graphitizable carbon particles of the negative electrode active material were changed to non-graphitizable carbon particles having an average particle diameter (d₅₀) of 4 μm (Experimental Example 8), 9 μm (Experimental Example 9) or 20 μm (Experimental Example 10) in Experimental Example 1.

### Test Example 7

The half cells obtained in Experimental Examples 8 to 10 were heated to 90° C. and charged and discharged repeatedly at a current value of 50 mA/g and in a voltage range of 0 to 1.2 V, whereby the discharged capacity and initial irreversible capacity were obtained. The results are shown in Table 3.

TABLE 3

| Average particle | | |
|---|---|---|
| diameter (d₅₀) of | | Initial |
| non-graphitizable | Discharged | irreversible |
| carbon particles | capacity | capacity |
| (μm) | (mAh/g) | (mAh/g) |
| 4 | 250 | 150 |
| 9 | 250 | 70 |
| 20 | 220 | 65 |

From the results shown in Table 3, it can be seen that the initial irreversible capacity is large when the average particle diameter (d₅₀) of non-graphitizable carbon is relatively small, that is, 4 μm; and the discharged capacity is reduced when the average particle diameter (d₅₀) of non-graphitizable carbon is relatively large, that is, 20 μm. On the contrary, it can be seen that excellent performance is exhibited in which the discharged capacity is large and the initial irreversible capacity is relatively small when the average particle diameter (d₅₀) of non-graphitizable carbon is 9 μm. From these results, it is suggested that a sodium secondary battery including non-graphitizable carbon having an average particle diameter (d₅₀) of 5 to 15 μm, preferably 7 to 12 μm as a negative electrode active material shows excellent performance that the discharged capacity is large and the initial irreversible capacity is relatively small.

### Experimental Examples 11 and 12

Sodium secondary batteries were obtained respectively by carrying out the same procedure as in Example 1 except that the electrolyte was changed to a mixed molten salt electrolyte [P13FSA/NaFSA (molar ratio): 6/4, the content percentage of sodium cations in all the cations in the electrolyte: 40% by mol, the amount of NaFSA per 1 mol of the mixture of P13FSA and NaFSA: 0.4 mol, and the content of water: 0.015% by mass (Experimental Example 11) or 0.005% by mass (Experimental Example 12)], respectively, in Example 1.

### Test Example 8

The sodium secondary batteries obtained in Experimental Examples 11 and 12 were heated to 90° C., and thereafter a charge and discharge test was carried out at a charge rate and a discharge rate: a current value of 0.2 C rate and in a voltage range of 1.5 to 3.5 V, thereby giving the initial irreversible capacity. As a result, the initial irreversible capacity of the negative electrode of the sodium secondary battery in which the content of water in an electrolytic solution was 0.015% by mass was 70 mAh/g. On the contrary, the initial irreversible capacity of the negative electrode of the sodium secondary battery in which the content of water in the electrolytic solution was 0.005% by mass was 50 mAh/g. These results show that it is possible to effectively reduce the initial irreversible capacity by limiting the content of water in the sodium secondary battery as much as possible. Therefore, it can be seen that the content of water in the molten salt electrolyte is desired to be as small as possible, and the content of water is desirably not more than 0.01% by mass, more preferably not more than 0.005% by mass.

### Example 13

EMIFSA and NaFSA were mixed with each other so that EMIFSA/NaFSA (molar ratio) was 7/3, thereby giving a mixed molten salt electrolyte of EMIFSA and NaFSA [EMIFSA/NaFSA (molar ratio): 7/3, the content percentage of sodium cations in all the cations in the electrolyte: 30% by mol, and the amount of NaFSA per 1 mol of the mixture of EMIFSA and NaFSA: 0.3 mol] as the electrolyte. A sodium secondary battery was obtained by the same procedure as in Example 1 except that the electrolyte was changed to the mixed molten salt electrolyte obtained above in Example 1.

### Example 14

EMIFSA and NaFSA were mixed with each other so that EMIFSA/NaFSA (molar ratio) was 6/4, thereby giving a mixed molten salt electrolyte of EMIFSA and NaFSA [EMIFSA/NaFSA (molar ratio): 6/4, the content percentage of sodium cations in all the cations in the electrolyte: 40% by mol, and the amount of NaFSA per 1 mol of the mixture of EMIFSA and NaFSA: 0.4 mol] as the electrolyte. A sodium secondary battery was obtained by the same procedure as in Example 1 except that the electrolyte was changed to the mixed molten salt electrolyte obtained above in Example 1.

### Example 15

EMIFSA and NaFSA were mixed with each other so that EMIFSA/NaFSA (molar ratio) was 5/5, thereby giving a mixed molten salt electrolyte of EMIFSA and NaFSA [EMIFSA/NaFSA (molar ratio): 5/5, the content percentage of sodium cations in all the cations in the electrolyte: 50% by mol, and the amount of NaFSA per 1 mol of the mixture of EMIFSA and NaFSA: 0.5 mol] as the electrolyte. A sodium secondary battery was obtained by the same procedure as in Example 1 except that the electrolyte was changed to the mixed molten salt electrolyte obtained above in Example 1.

### Test Example 9

The sodium secondary batteries obtained in Examples 13 to 15 and the sodium secondary battery obtained in Example 5 were subjected to a charge and discharge test under low-temperature conditions at 10° C., at a discharge rate: a current value of 0.05 C rate, at a discharge rate: three types of current values of 0.1 C rate, 0.2 C rate, and 0.5 C rate, and in a voltage range of 1.5 to 3.5 V. The results are shown in Table 4. In the table, note that the discharged capacity ratio at each discharge rate in the charge and discharge test at 10° C. is a value taking the discharged capacity ratio obtained by charge at 0.2 C and discharge at 0.1 C at 60° C. as 100%.

TABLE 4

| | Discharged capacity ratio (%) at each | | |
|---|---|---|---|
| | discharge rate at 10° C. | | |
| | Discharge | Discharge | Discharge |
| Composition | rate | rate | rate |
| (molar ratio) | 0.1 C | 0.2 C | 0.5 C |
| EMIFSA/NaFSA | 98 | 92 | 47 |
| (7/3) | | | |
| EMIFSA/NaFSA | 98 | 91 | 48 |
| (6/4) | | | |
| EMIFSA/NaFSA | 78 | 44 | 21 |
| (5/5) | | | |
| P13FSA/NaFSA | 90 | 49 | 24 |
| (6/4) | | | |

From the results shown in Table 4, it can be seen that the mixture of sodium bis(fluorosulfonyl)amide and 1-ethyl-3-methylimidazolium as well as the mixture of sodium bis(fluorosulfonyl)amide and N-methyl-N-propylpyrrolidinium bis(fluorosulfonyl)amide have excellent discharge performance even in a low-temperature region of 10° C. The reason for this is that the mixture of sodium bis(fluorosulfonyl)amide and N-methyl-N-propylpyrrolidinium bis(fluorosulfonyl)amide or the mixture of sodium bis(fluorosulfonyl)amide and 1-ethyl-3-methylimidazolium has electrochemical stability and low viscosity of the electrolyte. Therefore, from these results, it is suggested that an electrolyte including at least one selected from the group consisting of the mixture of sodium bis(fluorosulfonyl)amide and N-methyl-N-propylpyrrolidinium bis(fluorosulfonyl)amide and the mixture of sodium bis(fluorosulfonyl)amide and 1-ethyl-3-methylimidazolium is particularly useful as the electrolyte of the sodium secondary battery.

1. A sodium secondary battery comprising:
a positive electrode which includes a positive electrode current collector and a positive electrode material, the positive electrode material being carried on the positive electrode current collector, wherein the positive electrode material comprises a positive electrode active material reversibly containing sodium cation;
a negative electrode which includes a negative electrode current collector and a negative electrode material, the negative electrode material being carried on the negative electrode current collector, wherein the negative electrode material comprises a negative electrode active material reversibly containing sodium cation;
an electrolyte interposed at least between the positive electrode and the negative electrode; and
a separator for retaining the electrolyte and separating the positive electrode and the negative electrode from each other,
wherein the negative electrode active material is amorphous carbon,
the negative electrode active material further comprises a binder which does not contain halogen atoms,
the electrolyte is a molten salt electrolyte which is a mixture of a salt composed of sodium cation and an anion and a salt composed of an organic cation and an anion,
the content percentage of a metal cation other than the sodium cation in all the cations in the molten salt electrolyte is not more than 5% by mol.

2. The sodium secondary battery according to claim 1, wherein the amorphous carbon is non-graphitizable carbon.

3. The sodium secondary battery according to claim 2, wherein the shape of the non-graphitizable carbon is particle shape, and the average particle diameter (d₅₀) of each particle is 5 to 15 μm.

4. The sodium secondary battery according to claim 3, wherein the average particle diameter (d₅₀) of each particle is 7 to 12 μm.

5. The sodium secondary battery according to claim 1, wherein the content of water in the molten salt electrolyte is not more than 0.01% by mass.

6. The sodium secondary battery according to claim 1, wherein the content of water in the molten salt electrolyte is not more than 0.005% by mass.

7. (canceled)

8. The sodium secondary battery according to claim 1, wherein the anion is a sulfonyl amide anion represented by the formula (I): 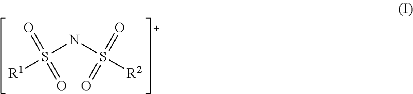
wherein R¹ and R² each independently represent a halogen atom or an alkyl group having 1 to 10 carbon atoms and having a halogen atom.

9. The sodium secondary battery according to claim 8, wherein the sulfonyl amide anion is at least one selected from the group consisting of a bis(trifluoromethyl sulfonyl)amide anion, a fluorosulfonyl(trifluoromethyl sulfonyl)amide anion, and a bis(fluorosulfonyl)amide anion.

10. The sodium secondary battery according to claim 1, wherein the organic cation is at least one selected from the group consisting of: a cation represented by the formula (IV): 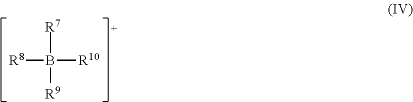
wherein R⁷ to R¹⁰ each independently represent an alkyl group having 1 to 10 carbon atoms or an alkyloxy alkyl group having 1 to 10 carbon atoms, and B represents a nitrogen atom or a phosphorus atom;
an imidazolium cation represented by the formula (V): 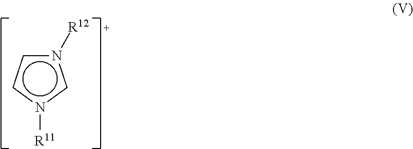
wherein R¹¹ and R¹² each independently represent an alkyl group having 1 to 10 carbon atoms;
a pyridinium cation represented by the formula (VII): 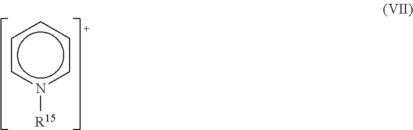
wherein R¹⁵ represents an alkyl group having 1 to 10 carbon atoms;
a pyrrolidinium cation represented by the formula (X): 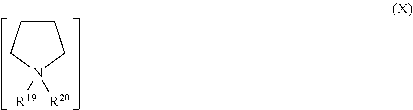
wherein R¹⁹ and R²⁰ each independently represent an alkyl group having 1 to 10 carbon atoms; and
a piperidinium cation represented by the formula (XII): 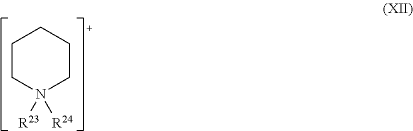
wherein R²³ and R²⁴ each independently represent an alkyl group having 1 to 10 carbon atoms.

11. The sodium secondary battery according to claim 1, wherein the organic cation is at least one selected from the group consisting of N-methyl-N-propylpyrrolidinium cation and 1-ethyl-3-methylimidazolium (EMI) cation.

12. The sodium secondary battery according to claim 1, wherein the molten salt electrolyte is at least one selected from the group consisting of a mixture of sodium bis(fluorosulfonyl)amide and N-methyl-N-propylpyrrolidinium bis(fluorosulfonyl)amide and a mixture of sodium bis(fluorosulfonyl)amide and 1-ethyl-3-methylimidazolium (EMI), and the amount of sodium bis(fluorosulfonyl)amide per 1 mol of the mixture is 0.1 to 0.55 mol.

13. The sodium secondary battery according to claim 12, wherein the amount of sodium bis(fluorosulfonyl)amide per 1 mol of the mixture is 0.2 to 0.5 mol.
